(19) United States
(12) Patent Application Publication
(10) Pub. No.: US 2024/0041062 A1
(43) Pub. Date: Feb. 8, 2024

(54) FILLERS FOR CHOCOLATE AND OTHER CONSUMABLES

(71) Applicant: Voyage Foods, Inc., Oakland, CA (US)

(72) Inventors: Kelsey Tenney, Oakland, CA (US); Adam Jacob Maxwell, San Francisco, CA (US)

(21) Appl. No.: 18/221,975

(22) Filed: Jul. 14, 2023

Related U.S. Application Data
(60) Provisional application No. 63/389,483, filed on Jul. 15, 2022.

(51) Int. Cl. A23G 1/48; A23G 1/34; A23G 1/36; A23G 1/40

(52) U.S. Cl. CPC A23G 1/48; A23G 1/34; A23G 1/36; A23G 1/40

(57) ABSTRACT

Methods and materials for using plant seeds (e.g., grape seeds) as a filler ingredient for chocolate, cocoa, or other consumable products are provided herein.

### CROSS-REFERENCE TO RELATED APPLICATIONS

This application claims priority from U.S. Provisional Application Ser. No. 63/389,483, filed Jul. 15, 2022. The disclosure of the prior application is considered part of (and is incorporated by reference in) the disclosure of this application.

### TECHNICAL FIELD

This document relates to methods and materials for processing and using non-cocoa plant seeds (e.g., grape seeds) and other non-cocoa plant parts as filler ingredients for chocolate, cocoa, and other consumable products.

### BACKGROUND

In general, chocolate contains a few basic ingredients: cocoa butter, cocoa solids, and added sugar. Cocoa butter is the fat extracted from cocoa beans. Up to 50% of cocoa can be fat, including both saturated fatty acids (e.g., palmitic acid and stearic acid) and mono-unsaturated acid (e.g., oleic acid). Cocoa butter provides cocoa flavor and aroma, and is a major ingredient in all types of chocolates. Dry cocoa solids are what remains after cocoa butter is extracted from chocolate liquor (cocoa beans that have been ground into a liquid state). Untreated cocoa solids are bitter and acidic, but treating cocoa with an alkaline agent to neutralize the acid (referred to as “Dutch process” or “dutching”) can improve the flavor. Sugar typically is added to chocolate as another basic ingredient. Cocoa beans contain a significant amount of carbohydrates, but most are in the form of starch and dietary fibers rather than in the sugar state.

In some cases, chocolate can contain a filler to replace at least a portion of the cocoa solids. Cocoa solids can be challenging to replace, however, because they are inherently difficult to replicate in flavor in the final product. Their unique hydrophobic, high fiber properties also are not commonly found in readily commercialized food ingredients. Where those properties do exist in readily commercialized food ingredients, they are often accompanied by undesirable characteristics such as off-notes from oils and/or high carbohydrate content. Attempts to isolate specific parts of the cocoa solids have resulted in a refined ingredient that lacks complexity and is unsuitable as a bulk replacement for cocoa solids.

Currently used fillers include sugar, small percentages of vegetable fat, and cheaper cocoa, but such fillers do not work well as 1:1 replacements, and they can negatively impact the flavor of the chocolate. For example, carob is a product that has often been touted as a chocolate replacement and has been sold for decades as a well-refined bar product. However, carob is lacking in flavor as compared to cocoa, and has not been able to replace cocoa in a meaningful way because of its off-putting, bean-like flavor that is very dissimilar to that of chocolate. Attempts to manipulate the inherent properties of carob have not resulted in products suitable as replacements for cocoa.

Various fillers and coatings also have been utilized as substitutes for other cocoa-based ingredients in chocolate confections. However, none of the existing chocolate fillers and compound coatings have successfully replaced the actual dry cocoa solids (which constitute the bulk of the body and substance of cocoa beans, the source material from which cocoa butter and cocoa solids originate) in a consumable chocolate product.

### SUMMARY

The methods and materials provided herein take a new approach to creating cocoa fillers and coatings by solving a long-felt need in the chocolate industry: finding a suitable replacement of all or a portion of dry cocoa solids in a chocolate product. In particular, the methods and materials provided herein solve the problem by providing products and methods for generating padded chocolate in which all or a portion of the dry cocoa solids are replaced with processed plant materials (e.g., fruit seeds, such as grape seeds) that are not from cocoa. Compositions containing processed plant materials as described herein typically are inexpensive (which can reduce cost and supply chain volatility) and can maintain a strong cocoa flavor with few, if any, off-notes. In addition to having the aromas, flavors, smoothness, and body of high-end chocolates, consumables made with the materials provided herein typically possess physical and chemical properties that are remarkably similar to those of traditional chocolate made with ground cocoa beans. In addition, the methods and materials disclosed herein can provide high-fiber ingredients that minimally impact the nutritional profile of the finished product. For example, the processed plant materials provided herein do not share the macronutrient considerations posed by some grains and/or sugars, which are unsuitable as replacements for cocoa solids due to their carbohydrate/sugar content.

As described herein, it has now been demonstrated that processed plant seeds (e.g., grape seeds, which are a byproduct of wine and juice production and therefore are readily available) can be used to replace dry cocoa solids for chocolate, cocoa, padded chocolate, and other related products in a dried, roasted, and/or pH-adjusted state. Further, it has surprisingly been discovered that whole grape seeds, which are not currently used as a food source, are similar in their fiber and protein content to whole cocoa beans (see, Example 11).

The methods provided herein for processing plant seeds (e.g., non-cocoa fruit seeds, such as grape seeds) successfully overcome several technical challenges. For example, grape seeds and other types of plant seeds (e.g., cranberry, blueberry, raspberry, strawberry, blackberry, pomegranate, date, and fenugreek seeds) are inherently very astringent due to their high tannin content. In fact, due to the high astringency of grape seeds, a top priority when pressing grapes to make wine is to prevent breaking the seeds so that the grape juice is not contaminated with the high levels of tannins contained therein. The pH adjustment, roasting, and temperature treatment steps in the methods provided herein can aid in controlling and manipulating the tannin profile of grape seeds. Another challenge is that grape seeds and other types of plant seeds (e.g., cranberry seeds, blueberry seeds, raspberry seeds, strawberry seeds, blackberry seeds, pomegranate seeds, date seeds, and fenugreek seeds) typically are difficult to grind because of their high lignin and liquid oil contents. Lignans are found abundantly in grape seed, berry seeds, and other plants, where they are concentrated in the cell walls of the seeds. The grinding techniques used in the methods provided herein can address this issue, resulting in particles of size similar to that of finely milled dry cocoa solids. One benefit of grinding the tough, fibrous high-lignin seeds is that the bioavailability of the beneficial compounds that are contained in the lignans can be improved. When berry seeds are consumed whole without crushing the seeds, for example, the bioavailability of lignans has been found to be relatively low since the seeds pass through the intestines and most of the lignan content is lost.

Yet another challenge is that the flavor of grape seeds and other non-cocoa plant seeds is not inherently cocoa-like. However, the methods provided herein for processing seeds, including grape seeds, cranberry seeds, raspberry seeds, blackberry seeds, pomegranate seeds, and strawberry seeds, can result in a product having the desired cocoa flavor, with reduced off-flavors. See, e.g., the results discussed in Example 12 herein, which demonstrated that although the above-referenced seeds are not inherently cocoa-like, they developed cocoa flavors after being processed as described herein.

It is to be noted that the approaches described herein to transform non-cocoa plant seeds into a substitute for cocoa is different from the general approach taken in the food industry to create alternative products or substitutes for natural ingredients or products. In general, the approach used in the food industry is to purify a food product to cut out as much off-color, off-flavor, and off-texture as possible. Margarine, for example, is a refined, bleached, and deodorized fat that has been manipulated to have the texture of dairy butter and mixed with added flavors and colors to mimic dairy butter. In contrast, the materials and methods described herein were identified and developed by investigating different natural food sources to identify similar qualities, instead of synthesizing an imitation product from scratch. Once fruit seeds were identified as candidates, the described methods for processing the seeds into products that closely resemble cocoa were developed.

This document provides materials and methods for using plant seeds (e.g., non-cocoa plant seeds, such as grape seeds and berry seeds) or other plant parts as an ingredient for padding chocolate, cocoa, or other consumable products. The processing methods provided herein can include, without limitation, pH adjustment, roasting, and/or grinding steps that can generate filler products with surprisingly accurate cocoa-like flavor, as demonstrated in a descriptive sensory test against real chocolate described in Example 8 herein. The sensory test results demonstrated that a 75 wt % substitution of dry cocoa solids with a processed grape seed filler resulted in a chocolate product that was indistinguishable from real chocolate.

The plant-based (e.g., seed-based) fillers provided herein can be used in a dried, roasted, and/or pH-adjusted state. The use of such fillers can reduce the cost of a final product containing chocolate or cocoa, reduce the volatility of the price of the finished product (which can occur due to changing climatic conditions, workforce issues, political agendas in the region, etc.), increase the flexibility of chocolate and cocoa producers to maintain flavor consistency season to season as a blending tool, and increase the processing function of liquid chocolate.

In a first aspect, this document features a composition containing, or consisting essentially of roasted and ground fruit seeds. In some cases, the ground fruit seeds have a particle size less than 350 microns. The fruit seeds can be grape seeds. The grape seeds can be selected from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, grenache blanc grapes, and any combination thereof. In some cases, the fruit seeds can be selected from cranberry, raspberry, blueberry, strawberry, blackberry, pomegranate, kiwi, watermelon, muskmelon, cantaloupe, honeydew, papaya, passionfruit, starfruit, tomato, tomatillo, dragon fruit, guava, soursop, calamansi, pumpkin, squash, okra, cucumber, bell pepper, eggplant, pears, apples, cherimoya, pineapple, quince, lingonberries, date, fenugreek, and any combination thereof. The ground fruit seeds have a particle size less than 250 microns or less than 150 microns.

In another aspect, this document features a consumable product comprising a filler containing, or consisting essentially of roasted and ground fruit seeds. In some cases, the ground fruit seeds have a particle size less than 350 microns. The consumable product can be a chocolate. The chocolate can include: about 0.01% to about 35% by weight of the filler; about 20% to about 55% by weight cocoa butter; about 20% to about 60% by weight sugar; and optionally about 0.5% to about 25% by weight cocoa solids. In some cases, the chocolate can include: about 17.5% by weight of the filler; about 37.5% by weight cocoa butter; about 40% by weight sugar; and optionally about 5% by weight cocoa solids.

The fruit seeds can be grape seeds. The grape seeds can be selected from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, grenache blanc grapes, and any combination thereof. In some cases, the fruit seeds can be from cranberry, raspberry, blueberry, strawberry, blackberry, pomegranate, kiwi, watermelon, muskmelon, cantaloupe, honeydew, papaya, passionfruit, starfruit, tomato, tomatillo, dragon fruit, guava, soursop, calamansi, pumpkin, squash, okra, cucumber, bell pepper, eggplant, pears, apples, cherimoya, pineapple, quince, lingonberries, date, fenugreek, and any combination thereof. The ground fruit seeds have a particle size less than 250 microns or less than 150 microns.

In one aspect, this document features a method for making a substitute for dry cocoa solids from non-cocoa seeds, wherein the method includes: (a) treating a plurality of non-cocoa fruit seeds with a chemical solution and/or an enzymatic solution, thereby producing treated seeds; (b) reducing the moisture content of the treated seeds to 25% w/w or less of the treated seeds, thereby producing dried seeds; (c) roasting the dried seeds, thereby producing roasted seeds; and (d) grinding the roasted seeds, thereby producing a ground seed composition, wherein the composition is effective as a substitute for dry cocoa solids.

In another aspect, this document features a method for making a chocolate product containing a filler prepared from non-cocoa seeds, wherein said method includes: (a) treating a plurality of non-cocoa fruit seeds with a chemical solution and/or an enzymatic solution, thereby producing treated seeds; (b) reducing the moisture content of the treated seeds to 25% w/w or less of the treated seeds, thereby producing dried seeds; (c) roasting the dried seeds, thereby producing roasted seeds; and (d) grinding the roasted seeds, thereby producing a ground seed composition, wherein the composition is used as all or a portion of the filler.

In some cases, the plurality of non-cocoa fruit seeds are cleaned prior to step (a) to remove impurities, e.g., chaff, broken material, stones, skins, stems, and/or sticks. The plurality of non-cocoa fruit seeds can be cleaned using a destoner, a scalping deck, an aspiration channel, a sizing deck, an optical sorter, a sieve, or a combination thereof, such that the impurities are less than 0.5% w/w of the seeds.

In some cases, step (a) includes using a chemical solution comprising a caustic agent (e.g., sodium hydroxide, potassium hydroxide, sodium carbonate, calcium carbonate, calcium hydroxide, potassium bicarbonate, iodine, or a combination thereof), an acidulant (e.g., acetic, adipic, citric, fumaric, lactic, malic, phosphoric and tartaric acids, glucono-delta-lactone, or a combination thereof), and/or an oxidizing agent (e.g., hydrogen peroxide). The seeds can be treated with the chemical solution with agitation at 60° C. to 150° C. (e.g., 75° C. to 100° C.) for 30 minutes to 2 hours, such that the treated seeds have a pH of 5.5-10.5 (e.g., 8-10). In some cases, step (a) includes using an enzymatic solution comprising one or more enzymes comprising cellulase, tannase, pectinase, xylase, and/or hemicellulase, preferably cellulase and/or hemicellulose, in an aqueous solution. The seeds can be treated with the enzymatic solution with agitation for 30 minutes to 2 hours.

In some cases, step (a) includes treating the seeds with the chemical solution and/or the enzymatic solution by soaking, spraying, boiling, agitating, coating, or a combination thereof. In some cases, step (a) includes treating the seeds with both the chemical solution and the enzymatic solution, either simultaneously or sequentially.

In some cases, step (b) includes reducing the moisture content of the treated seeds to 20% w/w, 15% w/w, 10% w/w, 6% w/w, or less of the treated seeds.

In some cases, step (c) includes roasting the dried seeds at 125° C. to 200° C., preferably 140° C. to 200° C. or 150° C. to 175° C., for 20 minutes to 2 hours. The moisture content of the roasted seeds can be less than 2% w/w of the roasted seeds.

In some cases, step (d) includes using one or more dry milling techniques and/or one or more wet milling techniques, to produce the ground seed composition. In some cases, step (d) includes using a wet mill (e.g., a stone mill, a colloid mill, a blade mill, or a corundum mill) to grind the roasted seeds together with a fat or liquid oil. The fat or liquid oil can be in the amount of 30-60% by weight of the roasted seeds. In some cases, step (d) includes grinding the roasted seeds to a particle size less than about 350 μm, less than about 250 μm, or less than about 150 μm.

In one aspect, this document features a method for making a substitute for dry cocoa solids from non-cocoa seeds, wherein the method includes: (a) cleaning a plurality of non-cocoa fruit seeds to remove impurities, thereby producing cleaned seeds; (b) roasting the cleaned seeds at 125° C. to 200° C., preferably 140° C. to 200° C., for 20 minutes to 2 hours, thereby producing roasted seeds; and (c) grinding the roasted seeds, thereby producing a ground seed composition, wherein the composition is effective as a substitute for dry cocoa solids. In another aspect, this document features a method for making a chocolate product containing a filler prepared from non-cocoa seeds, wherein said method includes: (a) cleaning a plurality of non-cocoa fruit seeds to remove impurities, thereby producing cleaned seeds; (b) roasting the cleaned seeds at 125° C. to 200° C., preferably 140° C. to 200° C., for 20 minutes to 2 hours, thereby producing roasted seeds; and (c) grinding the roasted seeds, thereby producing a ground seed composition, wherein the composition is used as all or a portion of the filler. In some cases, the method further includes reducing the moisture content of the cleaned seeds prior to step (b). In some cases, step (c) includes using a wet mill (e.g., a stone mill, a colloid mill, a blade mill, or a corundum mill) to grind the roasted seeds together with a fat or liquid oil, wherein the fat or liquid oil is in the amount of 30-60% by weight of the roasted seeds. In some cases, step (d) includes grinding the roasted seeds to a particle size less than about 350 μm, less than about 250 μm, or less than about 150 μm.

In some cases, the chocolate product described herein further includes cocoa butter, sugar, and optionally cocoa solids. In some cases, the chocolate product described herein further includes a cocoa butter replacement, substitute, or equivalent (CBE), sugar, and optionally cocoa solids, seed meal, and/or lecithin.

As used herein, the term “traditional” or “reference” with reference to chocolate refer to chocolate products produced through standard chocolate making processes and containing standard chocolate ingredients, which include cocoa solids, cocoa butter, and sugar.

As used herein, the term “about” when used to refer to an amount of an ingredient or compound in a chocolate or other consumable product means±10% of the amount. As used herein, the term “about” when used to refer to measured characteristics of a chocolate or other consumable product means±20% of the reported value. As used herein, the term “about” when used to a condition for making a chocolate or other consumable product means±20% of the value.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and from the claims.

### DESCRIPTION OF DRAWINGS

FIG. 1 shows particle size analysis results of wet milled grapeseed and cocoa-free chocolates using Malvern® laser diffraction Particle Size Analyzer.

FIG. 2 shows particle size analysis results using dynamic light scattering/laser diffraction.

### DETAILED DESCRIPTION

This document provides materials and methods for using plant seeds (e.g., grape seeds) and/or other plant parts as the source of a filler ingredient that can be used for padding chocolate, cocoa, or other consumable products. In chocolate, for example, a filler provided herein can replace all or a portion of the cocoa solids. The plant-based (e.g., seed-based) fillers can be used in a dried, roasted, and/or pH-adjusted state. The use of such fillers can reduce the cost of a final product containing chocolate or cocoa, reduce the volatility of the price of the finished product (which can occur due to changing climatic conditions, workforce issues, and political agendas in the growing region), increase the flexibility of chocolate and cocoa producers to maintain flavor consistency season to season as a blending tool or a cocoa replacement tool, and increase the processing function of liquid chocolate. The fillers provide herein typically are not derived from cacao/cocoa (e.g., do not contain cacao or cocoa solids). The fillers can be prepared from, for example, a food stream waste product (e.g., seeds, stems, leaves, etc.). In some aspects, this document provides fillers that can be used in chocolate and other consumables. The fillers can be produced from, for example, food stream waste products. For example, a filler can include processed seeds (e.g., grape seeds or seeds from any other appropriate type of plant). Grape seeds can be useful for a variety of reasons. For example, the fiber and protein content of grape seeds is similar to that of cocoa beans on a solid basis. Grape seeds grow in a similar high acid, high sugar flesh as cocoa beans (grape to pod), which can result in a similar makeup of flavor precursors.

For example, after evaluating multiple plant and food sources (e.g., seeds, grains, roots, fruits, and vegetables), cocoa beans (cacao seeds) and grape seeds were identified as seeds that both have a very high tannin content, and it was discovered that this property can be manipulated for flavor and mouthfeel purposes. Details of the high tannin content in cocoa beans (cacao seeds) and grape seeds can be found, e.g., in Mohd Z. N., et al. (2020). Microanalysis of Cocoa Beans for Determination of Tannin Content Contributed to Cocoa Flavor. Malaysian Cocoa Journal 12(1): 154-161; and Ma Z. F., et al. Phytochemical Constituents, Health Benefits, and Industrial Applications of Grape Seeds: A Mini-Review. Antioxidants (Basel). 2017 Sep. 15; 6(3):71; each of which is incorporated herein by reference in its entirety. In addition, studies have shown that grape seeds and cocoa beans both have a high flavonoid content, which can be beneficial to human health. Details of the high flavonoid content in grape seeds and cocoa beans can be found, e.g., in Ma Z. F., et al. Phytochemical Constituents, Health Benefits, and Industrial Applications of Grape Seeds: A Mini-Review. Antioxidants (Basel). 2017 Sep. 15; 6(3):71; and Katz D. L., et al. Cocoa and chocolate in human health and disease. Antioxid Redox Signal. 2011 Nov. 15; 15(10):2779-811; each of which is incorporated herein by reference in its entirety.

They are also high in lignans, which are a group of bioactive compounds typically concentrated in the seeds of plants. Lignans have been associated with a diverse spectrum of health-promoting effects, such as antioxidant, antiviral, and antitumorigenic. Details of lignans can be found, e.g., in Smeds, A., et al. (2012). Content, composition, and stereochemical characterisation of lignans in berries and seeds. Food Chemistry. 194. 1991, which is incorporated herein by reference in its entirety.

In addition, from a production standpoint, grape seeds are a byproduct of wine and juice production, and therefore are readily available as an ingredient. They are typically treated as waste and by some estimates, about 10-12 kg of grape seeds per 100 kg of wet residues are produced by the wine industry. As such, grape seeds are a relatively inexpensive source of healthful dietary fiber and antioxidant-rich lignans, amounting to 38-52% on a dry matter basis. Details can be found, e.g., in Ma Z. F., et al. Phytochemical Constituents, Health Benefits, and Industrial Applications of Grape Seeds: A Mini-Review. Antioxidants (Basel). 2017 Sep. 15; 6(3):71, which is incorporated herein by reference in its entirety. Further, vineyards are often on a long-term planting schedule in areas where there is not a lot of previous vegetation, making the use of grape seeds as a replacement for cocoa beans a lower deforestation risk.

Moreover, it has now been discovered that processed grape seeds have several desirable traits, including rheological properties (e.g., viscosity), a cocoa-like chemical profile when roasted, and the ability to be milled to a refined paste having an appropriate particle size. As mentioned above, grape seeds surprisingly have similar characteristics to cacao seeds. For example, grape seeds possess hydrophobic, high fiber/cellulosic contents that mimic the way cocoa reacts to processing. This means that the fillers provided herein can be substituted where cocoa solids would normally be used, both in primary manufacturing formulations and also in consumer applications such as chocolate products for baking, beverages, confections, etc. The seeds can be ground to a fine particle size, similar to cocoa, so that the filler has a consistent smoothness that is undetectable by the human tongue. The characteristic of fine particulate size (e.g., under microns, under 35 microns, or even under 25 microns) can be an important marker of chocolate quality. Additionally, grape seeds can be consistently processed, and their color can be adjusted for consistency with the color of cocoa solids. In particular, grape seeds turn dark brown with roasting, and the color can be deepened with pH adjustment in the same way that cocoa powder coloration can be adjusted. Further, the seeds have a lower viscosity and yield value as compared to cocoa solids. This is a surprising and beneficial discovery because it means that the processed grape seed product has improved flow characteristics compared to traditional dry cocoa solids, reducing the need for unwanted yield value control ingredients such as polyglycerol polyricinoleate (PGPR) in chocolate formulations containing the filler provided herein.

Seeds from any appropriate type of grapes can be used. Types of grape seeds that can be used to produce fillers as described herein include, without limitation, seeds from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, and grenache blanc grapes. A combination of seeds from two or more types of grapes can be used. Since grape seeds are often obtained as waste from wineries and juice producers, seed lots can contain combinations of different varietals of grape seeds. Any combination of grape seeds from any combination of grape types can be used.

It is to be noted that other fruit and vegetable seeds beyond grape seeds also can be used in the fillers and methods provided herein. For example, seeds from, without limitation, cranberry, raspberry, blueberry, strawberry, blackberry, pomegranate, blackcurrant, kiwi, watermelon, muskmelon, cantaloupe, honeydew, papaya, passionfruit, starfruit, tomato, tomatillo, dragon fruit, guava, soursop, calamansi, pumpkin, squash, okra, cucumber, bell pepper, eggplant, pears, apples, cherimoya, pineapple, quince, lingonberries, date, and fenugreek can be used. Fruit seeds, including the seeds of all berries, are by-products of berry processing and are thus relatively inexpensive and readily available as food stream waste products. For example, most berries, including cranberries, raspberries, blueberry, blackcurrants are utilized in the food industry for juice production, and berry pressing results in the production of large amounts of berry-processing waste, including berry skins, seeds, and stems, which can account for about a quarter of the entire berry mass. Details can be found, e.g., in Alba, K., el al. (2019). Dietary Fibre from Berry-Processing waste and its impact on bread structure: a review. Journal of Science of Food and Agriculture. 99.10.1002/jsfa.9633, which is incorporated herein by reference in its entirety. A combination of seeds from two or more types of fruits can be used. Since fruit seeds, such as berry seeds, are often obtained as waste from juice producers and fruit processors, seed lots can contain combinations of different types of fruit seeds, including combinations of berry seeds. Any combination of fruit seeds from any combination of fruit sources can be used.

As demonstrated herein, fruit seeds other than grape seeds yielded results similar to grape seeds. In particular, Example 12 describes data from sensory evaluations conducted using various fruit seeds that were processed according to the same methods described herein for grape seeds and ground to a particle size of about 40 microns or less. As described in Example 12, replacements for dry cocoa solids were successfully generated using seeds from raspberry, blackberry, cranberry, blueberry, strawberry, and pomegranate. Date and fenugreek seeds also were tested and produced desirable results.

In some cases, a filler provided herein can be any food waste product from which most (e.g., at least 75%, at least 80%, at least 85%, at least 90%, or at least 95% by weight) of the starch, protein, sugar, fat-soluble components, and flavor have been removed, leaving behind cellulose, hemicellulose, lignin, and/or other insoluble fibers. In some embodiments, a solid substrate can include processed or unprocessed grains or grain products, legumes or legume seeds, oil plants or seeds, fruits or fruit products, roots, tubers, or root or tuber products, sugar processing by-products, or other plant by-products.

In some cases, a filler can include processed or unprocessed grains. Processing of grains can result in the removal or partial removal of one or more of: starch, protein, sugar, fat-soluble components, and flavors. Non-limiting examples of grains and grain products that can be used as fillers include atella, barley distillery by-products, broken rice or polished rice, barley grain, brown rice, brewers grains, cockspur grass (Echinochloa crusgalli) grain, corn gluten feed, corn distillers grain, corn gluten meal, ear maize, finger millet (Eleusine coracana) grain, foxtail millet (Setaria italica) grain, fonio (Digitaria exilis) grain, maize bran or hominy feed, maize green forage, maize cobs, maize stover, maize germ meal or maize germ, malt culms, maize grain, millet hulls, oat hulls or oat mill feed, oats, pearl millet (Pennisetum glaucum) grain, proso millet (Panicum miliaceum) grain, quinoa (Chenopodium quinoa), red oat (Avena sativa) grain, rice protein concentrate, rice bran or other rice by-products, rough rice (paddy rice), rice hulls, rye grain or by-products, sorghum by-products, starches, sorghum grain, tef (Eragrostis tef) grain, triticale, Venezuela grass (Paspalum fasciculatum), wheat (general), wheat germ, wheat bran, wheat grain, wheat distillers grain, wheat shorts, wheat middlings, feed flour, and mixtures thereof.

In some cases, a filler can be prepared from legumes or legume seeds. Non-limiting examples of legumes or legume seeds that can be used substrate include African locust bean (Parkia biglobosa or Parkia filicoidea), African yam bean (Sphenostylis stenocarpa), bambara barnut (Vigna subterranea) crop residue and straw, black gram (Vigna mungo), bambara barnut (Vigna subterranea) pods, shells and offals, blue lupin (Lupinus angustifolius) seeds, bambara barnut (Vigna subterranea) seeds, butterfly pea (Clitoria ternatea), carob (Ceratonia siliqua), common bean (Phaseolus vulgaris), centro (Centrosema molle), common vetch (Vicia sativa), chickpea (Cicer arietinum), cowpea (Vigna unguiculata) seeds, faba bean (Vicia faba), grass pea (Lathyrus sativus), guar (Cyamopsis tetragonoloba) forage, seed and meal, guanacaste (Enterolobium cyclocarpum), hairy vetch (Vicia villosa), horse gram (Macrotyloma uniflorum), jack bean (Canavalia ensiformis), lablab (Lablab purpureus), lima bean (Phaseolus lunatus), lentil (Lens culinaris), mat bean (Vigna aconitifolia), mung bean (Vigna radiata), narbon vetch (Vicia narbonensis), pea by-products, peanut seeds, pea protein concentrate, peanut skins, pea seeds, pigeon pea (Cajanus cajan) seeds, peanut forage, prickly sesban (Sesbania bispinosa), peanut hulls, purple vetch (Vicia benghalensis), peanut meal, rain tree (Albizia saman), rice bean (Vigna umbellata), sesban (Sesbania sesban), soybean seeds, soybean (general), sword bean (Canavalia gladiata), soybean forage, syrian mesquite (Prosopis farcta), soybean meal, tamarind (Tamarindus indica), tamarugo (Prosopis tamarugo), velvet bean (Mucuna pruriens), white lupin (Lupinus albus) seeds, winged bean (Psophocarpus tetragonolobus), yellow lupin (Lupinus luteus) seeds, and mixtures thereof.

In some cases, a filler can be prepared from oil plants or seeds or a combination of one or more oil plants and/or one or more seeds. Non-limiting examples of oil plants and seeds than can be used include almond kernels and by-products, argan (Argania spinosa), babassu (Attalea speciosa), borneo tallow nut (Shorea stenoptera) oil meal, bactris (Bactris gasipaes), camelina (Camelina sativa) seeds and oil meal, cotton (general), cashew (Anacardium occidentale) nuts and by-products, castor (Ricinus communis) seeds, oil meal and by-products, cotton straw and cotton crop residues, ceylon ironwood (Mesua ferrea), chia seed, cocoa butter, cottonseed hulls, cottonseed meal, copra meal and coconut by-products, crambe (Crambe abyssinica), corozo (Attalea cohune) seed and oil meal, doum palm (Hyphaene thebaica), dragon's head (Lallemantia iberica), flax straw and flax crop by-products, grape seeds and grape seed oil meal, hemp, jatropha (Jatropha sp.) kernel meal and other jatropha products, jojoba (Simmondsia chinensis), kapok (Ceiba pentandra), kenaf (Hibiscus cannabinus), karanja (Millettia pinnata), kusum (Schleichera oleosa), linseed meal, luffa (Luffa aegyptiaca), linseeds, macadamia (Macadamia integrifolia), moringa (Moringa oleifera), mahua (Madhuca longifolia), mustard oil meal and mustard bran, maize germ meal and maize germ, neem (Azadirachta indica), niger (Guizotia abyssinica), oil palm fronds and oil palm crop residues, olive oil cake and by-products, oil palm kernels, palm kernel meal, peanut seeds, palm oil mill effluent, peanut skins, palm press fibre, pinto peanut (Arachis pintoi), peanut forage, poppy (Papaver somniferum), peanut hulls, pumpkin, squash, gourd and other Cucurbita species, peanut meal, rapeseed forage, rapeseed hulls, rapeseed meal, rapeseeds, rubber (Hevea brasiliensis), safflower (Carthamus tinctorius) seeds and oil meal, sal (Shorea robusta) seeds and oil meal, soybean meal, soybean seeds, seje (Oenocarpus bataua), sunflower (general), sesame (Sesamum indicum) seeds and oil meal, shea butter, shea kernel, sickle pods, sunflower forage and crop residues, sunflower hulls and sunflower screenings, sunflower meal, sunflower seeds, soybean (general), soybean forage, soybean hulls, tung tree (Aleurites fordii), tomato seed cake, walnut (Juglans regia), watermelon (Citrullus lanatus) seeds and oil meal, and mixtures thereof. In some cases, a filler can be prepared from a fruit or fruit product. Non-limiting examples of fruits and fruit products that can be used include apple pomace and culled apples, banana (general), banana peels, banana fruits, banana leaves and pseudostems, breadfruit (Artocarpus altilis), breadnut (Brosimum ahcastrum), cashew (Anacardium occidentale) nuts and by-products, citrus pulp, fresh, citrus fruits, citrus seed meal, citrus molasses, citrus pulp, dried, colocynth (Citrullus colocynthis), date molasses, date palm leaves and date pedicels, date palm fruits, grape pomace, guava (Psidium guajava), grape seeds and/or grape seed oil meal, jackfruit (Artocarpus heterophyllus), kokum (Garcinia indica), luffa (Luffa aegyptiaca), mango (Mangifera indica) fruit and by-products, moringa (Moringa oleifera), melon (Cucumis melo), olive oil cake and by-products, papaya (Carica papaya) fruits, leaves and by-products, pineapple by-products, pineapple leaves, pineapple mill juice, pumpkin, squash, gourd and other Cucurbita species, sapucaia (Lecythis pisonis), Spanish lime (Mehcoccus bijugatus), seje (Oenocarpus bataua), tomato fruits, tomato pomace, tomato skins and tomato seeds, tomato leaves and crop residues, tomato seed cake, walnut (Juglans regia), watermelon (Citrullus lanatus) forage and fruit, watermelon (Citrullus lanatus) seeds and oil meal, and mixtures thereof. In some embodiments, the solid substrate comprises grape seeds.

Fillers also can be prepared from roots, tubers, and root or tuber products. Non-limiting examples of roots, tubers, and root or tuber products that can be used include arrowroot (Maranta arundinacea), beet molasses, canna (Canna indica), carrot (Daucus carota), cassava leaves and foliage, cassava peels, cassava pomace and other cassava by-products, cassava roots, Chinese yam (Dioscorea esculenta), enset (Ensete ventricosum) corms and pseudostems, fodder beet roots, maca, Jerusalem artichoke (Helianthus tuberosus), malanga (Xanthosoma sagittifolium), potato (Solanum tuberosum) by-products, potato (Solanum tuberosum) tubers, sugar beet pulp, dehydrated, sugar beet pulp, pressed or wet, sugar beet roots, sugar beet tops, sweet potato (Ipomoea batatas) by-products, sweet potato (Ipomoea batatas) forage, sweet potato (Ipomoea batatas) tubers, taro (Colocasia esculenta), white yam (Dioscorea rotundata), winged yam (Dioscorea alata), whitespot giant arum (Amorphophallus campanulatus), yacon (Smallanthus sonchifolius), yellow yam (Dioscorea cayenensis), and mixtures thereof. In some cases, a filler can be prepared from sugar processing by-products. Non-limiting examples of sugar processing by-products that can be used include beet molasses, sugar, molasses, sugar beet pulp, pressed or wet, sugarcane bagasse, sugarcane forage, whole plant, sugarcane juice, sugarcane molasses, sugarcane press mud, sugarcane tops, and mixtures thereof.

Other plant by-products that can be used to prepare fillers include, without limitation, carob (Ceratonia siliqua), citrus molasses, date molasses, date palm leaves and date pedicels, date palm seeds, enset (Ensete ventricosum) corms and pseudostems, leaf protein concentrate and grass juice, Mexican marigold (Tagetes erecta), mushrooms and spent mushroom substrate, molasses/urea blocks, potato (Solanum tuberosum) tubers, pyrethrum marc, spent hops, straws, sugarcane juice, sugarcane molasses, sugarcane press mud, vinasses, wood, wood sugar or wood molasses, and mixtures thereof.

This document also provides methods for making fillers. The fillers provided herein can be prepared using any appropriate methods.

In some cases, a filler can be prepared using ground plant seeds as a starting material. For example, ground seeds (e.g., ground grape seeds, cranberry seeds, raspberry seeds, blackberry seeds, strawberry seeds, blueberry seeds, pomegranate seeds, kiwi seeds, watermelon seeds, muskmelon seeds, cantaloupe seeds, honeydew seeds, papaya seeds, passionfruit seeds, starfruit seeds, tomato seeds, tomatillo seeds, dragon fruit seeds, guava seeds, soursop seeds, calamansi seeds, pumpkin seeds, squash seeds, okra seeds, cucumber seeds, bell pepper seeds, eggplant seeds, pears seeds, apple seeds, cherimoya seeds, pineapple seeds, quince seeds, lingonberry seeds, thistle (nyger) seeds, currant seeds, or any other suitable seeds) can be ground to a particle size of about 5 to about 500 microns (e.g., about 5 to about 10 microns, about 10 to about 20 microns, about 20 to about 30 microns, about 25 microns, about 30 to about 50 microns, about 50 about 100 microns, about 100 to about 150 microns, about 150 to about 200 microns, about 200 to about 300 microns, about 300 to about 400 microns, or about 400 to about 500 microns) can be used as a starting material. The ground seeds can be treated with a caustic agent (e.g., sodium hydroxide, potassium hydroxide, sodium carbonate, calcium carbonate, calcium hydroxide, potassium bicarbonate, hydrogen peroxide, or iodine) and water at a pressure of 0-10 bar (e.g., 0-2 bar, 2-4 bar, 4-6 bar, 6-8 bar, or 8-10 bar), and at a temperature between about 45° C. and about 125° C. (e.g., about 45° C. to about 55° C., about 55° C. to about 75° C., about 65° C. to about 85° C., about 75° C. to about 95° C., about 85° C. to about 105° C., about 95° C. to about 115° C., about 105° C. to about 125° C., about 70° C., about 75° C., or about 80° C.) with blending for a suitable length of time (e.g., about to about 120 minutes, about 10 to about 90 minutes, about 20 to about 60 minutes, about 30 to about 45 minutes, about 20 minutes, about 30 minutes, or about 40 minutes) to reach a pH of about 5.5 to about 10.5 (e.g., about 5.5 to about 6.0, about 6.0 to about 6.5, about 6.5 to about 7.0, about 7.0 to about 7.4, about 7.4 to about 7.8, about 7.8 to about 8.2, about 8 to about 8.5, about 8.2 to about 8.6, about 8.6 to about 9, about 9 to about 9.5, about 9.5 to about 10.0, or about 10.0 to about 10.5). The seed mixture can then be dried (e.g., by tray drying, spray drying, drum drying, falling film evaporation, freeze drying, or vacuum drying). The mixture can then be combined with cocoa butter, a cocoa butter equivalent, replacement, or substitute, and/or one or more other plant-derived oils, and then milled (e.g., using a stone corundum mill or a colloid mill) and/or refined at a temperature less than about 65° C. (e.g., about 60° C. to about 65° C., about 55° C. to about 60° C., about 50° C. to about 55° C., about 50° C. to about 60° C., less than about 60° C., or less than about 55° C.), to reach a final particle size less than about 350 microns (e.g., about 300 to about 350 microns, about 250 to about 300 microns, about 200 to about 250 microns, about 150 to about 200 microns, about 125 to 150 microns, about 100 to about 125 microns, about 75 to about 100 microns, about 70 to about 75 microns, about 65 to about 70 microns, about 60 to about 65 microns, about 50 to about 60 microns, less than about 150 microns, less than about 100 microns, less than about 70 microns, less than about 65 microns, or less than about 60 microns). The milled mixture then can be passed through a sieve (e.g., 100 micron sieve) to yield a filler for inclusion in chocolate or another consumable.

Any appropriate method can be used to determine the particle size of material generated from ground seeds. In some cases, a micrometer screw gauge (micrometer caliper) or Hegman gauge (otherwise known as a grindometer) can be used. Other suitable methods include the use of a RoTap (rotary tap device) for dry materials, e.g., dry milled grape or fruit seeds, a laser diffraction particle size analyzer, and a dynamic light scattering/laser diffraction analyzer.

For the exemplary embodiments, particle size measurements were taken of dry and wet materials. For example, particle size measurements were taken of dry materials resulting from dry grinding and milling. Particle size measurements were also taken of wet material resulting from wet milling and chocolate products.

Unless otherwise specified herein, when referring to the particle size of a dry material obtained from dry grinding or milling, the measurements were taken using a RoTap. When referring to the particle size of a wet materials, measurements were taken using a micrometer screw and/or a Hegman gauge. Often, both the micrometer screw and the Hegman gauge were used for monitoring particle size during the grinding process or to assess a chocolate product. Particle size measurements of control 60.1% standard Barry Callebaut chocolate, grapeseed chocolate, blends of traditional chocolate and grapeseed chocolate (“padded chocolate”), cocoa-free chocolate, and other chocolate products of the present invention were taken using a micrometer and/or Hegman gauge. As discussed below, the particle size of wet milled grapeseed and finished chocolate mass were also obtained by laser diffraction and/or dynamic light scattering/laser diffraction. A description of each method for testing the particle size of materials of the present invention is provided below.

In some cases, a filler can be prepared using whole plant seeds as a starting material. For example, whole seeds (e.g., grape seeds, cranberry seeds, raspberry seeds, blackberry seeds, strawberry seeds, blueberry seeds, pomegranate seeds, kiwi seeds, watermelon seeds, muskmelon seeds, cantaloupe seeds, honeydew seeds, papaya seeds, passionfruit seeds, starfruit seeds, tomato seeds, tomatillo seeds, dragon fruit seeds, guava seeds, soursop seeds, calamansi seeds, pumpkin seeds, squash seeds, okra seeds, cucumber seeds, bell pepper seeds, eggplant seeds, pears seeds, apple seeds, cherimoya seeds, pineapple seeds, quince seeds, lingonberry seeds, thistle (nyger) seeds, currant seeds, or any other suitable seeds) can be sifted (e.g., using a mesh) to remove stem pieces and/or other undesired plant material. The sifted seeds can be treated with a caustic agent (e.g., sodium hydroxide, potassium hydroxide, sodium carbonate, calcium carbonate, calcium hydroxide, potassium bicarbonate, hydrogen peroxide, or iodine) and water at a pressure of 0-10 bar (e.g., 0-2 bar, 2-4 bar, 4-6 bar, 6-8 bar, or 8-10 bar), and at a temperature between about 55° C. and about 95° C. (e.g., about 55° C. to about 75° C., about 65° C. to about 85° C., about 75° C. to about 95° C., about 70° C., about 75° C., or about 80° C.) with blending for a suitable length of time (e.g., about 5 to about 120 minutes, about 10 to about 90 minutes, about 20 to about 60 minutes, about 30 to about 45 minutes, about 20 minutes, about 30 minutes, or about 40 minutes) to reach a pH of about 5.5 to about (e.g., about 5.5 to about 6.0, about 6.0 to about 6.5, about 6.5 to about 7.0, about 7.0 to about 7.4, about 7.4 to about 7.8, about 7.8 to about 8.2, about 8.2 to about 8.6, about 8.6 to about 9, about 9 to about 9.5, about 9.5 to about 10, or about 8 to about 8.5). The seeds can then be separated from the liquid by sieving to yield a wet seeds fraction and a liquid fraction that contains dissolved solids. The wet seeds fraction can be roasted (e.g., by air roasting, conductive roasting, fire roasting, or radiative heat roasting), and the liquid fraction also can be roasted (e.g., by dry roasting). Any suitable roasting temperature can be used (e.g., about 300° F. to about 450° F., about 325° F. to about 425° F., or about 350° F. to about 400° F.). The roasted wet seeds then can be ground (e.g., using a burr mill, a roller mill, a pin mill, an air classifier mill, a hammer mill, a colloid mill if fat or liquid has been added, a stone mill, blade mill, jet mill, high impact mill, or espresso grinder), to achieve a particle size between about 20 microns and about 300 microns (e.g., about 20 to about 50 microns, about 50 to about 75 microns, about 75 to about 100 microns, about 100 to about 150 microns, about 150 to about 200 microns, about 200 to about 250 microns, or about 250 microns to about 300 microns). The roasted and milled wet seeds fraction can then be recombined with the roasted liquid fraction. Cocoa butter or one or more plant oils (e.g., corn oil, sunflower oil, palm oil, coconut oil, shea oil, illipe oil, mango kernel oil, palm kernel oil, canola oil, avocado oil, safflower oil, or any other appropriate plant oil) can be added, and the mixture can be milled (e.g., using a stone corundum mill or a colloid mill) at a temperature less than about 65° C. (e.g., about 60° C. to about 65° C., about 55° C. to about 60° C., about 50° C. to about 55° C., about 50° C. to about 60° C., less than about 60° C., or less than about 55° C.), to reach a final particle size less than about 350 microns (e.g., about 300 to about 350 microns, about 250 to about 300 microns, about 200 to about 250 microns, about 150 to about 200 microns, about 125 to 150 microns, about 100 to about 125 microns, about 75 to about 100 microns, about 70 to about 75 microns, about 65 to about 70 microns, about 60 to about 65 microns, about 50 to about 60 microns, less than about 150 microns, less than about 100 microns, less than about 70 microns, less than about 65 microns, or less than about 60 microns). The milled mixture then can be passed through a sieve (e.g., 100 micron sieve) to yield a filler for inclusion in chocolate or another consumable.

Other methods for preparing a filler from whole plant seeds can include cleaning whole seeds (e.g., using one or more of a destoner, a scalping deck, an aspiration channel, a sizing deck, an optical sorter, and a sieve) to remove unwanted chaff, broken material, and other products of agricultural origin (e.g., stones, fruit skins, stems, sticks, etc.). The whole seeds can be treated with a caustic solution (e.g., sodium hydroxide, potassium hydroxide, sodium carbonate, calcium carbonate, calcium hydroxide, potassium bicarbonate, hydrogen peroxide, or iodine) and water at a pressure of 0-10 bar (e.g., 0-2 bar, 2-4 bar, 4-6 bar, 6-8 bar, or 8-10 bar), and at an elevated temperature (e.g., about 55° C. and about 95° C., about 55° C. to about 75° C., about 65° C. to about 85° C., about 75° C. to about 95° C., about 70° C., about 75° C., or about 80° C.) with agitation for a suitable length of time (e.g., about 5 to about 120 minutes, about 10 to about 90 minutes, about 20 to about 60 minutes, about 30 to about 45 minutes, about 20 minutes, about 30 minutes, or about 40 minutes), to reach a pH of about 7.8 to about 9.2 (e.g., about 7.8 to about 8.2, about 8.2 to about 8.6, about 8.6 to about 9, about 9 to about 9.2, or about 8 to about 9). In some cases, the treated seeds can be dutched, in which case the seed mixture can be dried (e.g., by tray drying, spray drying, drum drying, or vacuum drying). The seeds can be sieved to separate the wet seeds from the liquid, and the two streams can be dried separately. Alternatively, a vacuum can be pulled to evaporate moisture from the seed slurry. In some cases, one or more enzymes (e.g., cellulase, tannase, pectinase, xylase, or hemicellulose) can be added to the seeds, optionally along with water and/or one or more additional agents (e.g., a caustic material, an acidulant, or hydrogen peroxide). The seeds and solids can be roasted using, for example, convection, conduction, infrared, or a combination thereof. The roasted seeds and other solids from the roasting step can then be ground using, for example, a crushing mill, a burr mill, an espresso grinder, a stone mill, a blade mill, a hammer mill, an air classifier mill, a high impact mill or a jet mill, and optionally sifted, to yield a filler for inclusion in chocolate or another consumable.

This document also provided methods for making compositions (e.g., chocolate and other consumables) containing the fillers provided herein. Any appropriate method can be used to prepare a composition (e.g., a chocolate or other consumable) containing a filler provided herein. In some cases, the methods can include combining a filler provided herein (e.g., a grape seed filler) with cocoa butter, sugar, and optionally cocoa solids, in any appropriate amounts. In some cases, the methods can include combining a filler provided herein (e.g., a grape seed filler) with a cocoa butter replacement, substitute, or equivalent (CBE), sugar, optionally cocoa solids, and optionally a seed meal, in any appropriate amounts to make compositions (e.g., chocolate and other consumables) that are free of cocoa ingredients (e.g., compositions in which all of the cocoa solids and/or cocoa butter have been replaced with cocoa-free ingredients). For example, a composition provided herein can contain from about 0.01% to about 35% by weight (e.g., about 0.01 wt % to about 0.05 wt %, about 0.05 wt % to about 0.1 wt %, about 0.1 wt % to about 0.5 wt %, about 0.5 wt % to about 1 wt %, about 1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 10 wt %, about 12.5 wt %, about 15 wt %, about 17.5 wt %, about 20 wt %, about 22.5 wt %, or about 25 wt %) filler (e.g., grapeseed filler).

In some cases, a composition provided herein can contain about 20% to about 55% by weight (e.g., about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 30 wt %, about 32.5 wt %, about 35 wt %, about 37.5 wt %, about 40 wt %, about 42.5 wt %, or about 45 wt %) cocoa butter.

In some cases, a composition provided herein can contain about 20% to about 60% by weight (e.g., about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 35 wt %, about 37.5 wt %, about 40 wt %, about 42.5 wt %, or about 45 wt %) sugar (e.g., sucrose, dextrose, lactose, fructose, or maltose).

In some cases, a composition provided herein can contain about 0.5% to about 25% by weight (e.g., about 0.5 wt % to about 0.75 wt %, about 0.75 wt % to about 1 wt %, about 1 wt % to about 3 wt %, about 3 wt % to about 4 wt %, about 4 wt % to about 5 wt %, about 5 wt % to about 5.5 wt %, about 5.5 wt % to about 6 wt %, about 6 wt % to about 7 wt %, about 7 wt % to about 10 wt %, about 10 wt % to about 15 wt %, about 15 wt % to about 20 wt %, about 20 wt % to about 25 wt %, about 4.5 wt %, about 5 wt %, about 5.5 wt %, about 6 wt %, or about 6.5 wt %) cocoa solids.

In some cases, a chocolate can be prepared from cocoa butter (and/or CBE), sugar, optionally cocoa solids, optionally seed meal, and/or optionally lecithin, in combination with a filler provided herein. For example, a filler (e.g., a grapeseed filler) can be combined with cocoa butter (or CBE), sugar, and optionally cocoa solids and/or seed meal and blended together with grinding for 24 to 72 hours (e.g., 24 to 36, 36 to 48, 48 to 60, or 60 to 72 hours) to yield a particle size of about 25 to 35 microns. The resulting chocolate can be tempered and molded, followed by cooling and release of the chocolate from the molds.

In some cases, a filler (e.g., a grapeseed filler) can be mixed with one or more sugars, cocoa butter (and/or CBE), and optionally cocoa solids and/or oil seed meal (e.g., at about 30 to about 40° C. for about 10 to about 60 minutes). The combination can be emulsified (e.g., using a ball mill) at suitable temperature (e.g., up to about 40° C.) until the particle size is less than about 30 microns (e.g., less than 25 microns, or less than 20 microns). The resulting chocolate can then be solidified (e.g., at about 10 to about 15° C. in mold blocks). In some cases, the chocolate can be de-molded and optionally further processed. For example, the chocolate can be melted, tempered, and deposited into molds (e.g., bar molds) and cooled (e.g., at about 5° C. to about 20° C., or about 10° C. to about 15° C.), or deposited onto a cooling belt to produce chips or chunks.

In some cases, a filler (e.g., a grapeseed filler) can be mixed with one or more sugars, cocoa butter (and/or CBE), and optionally cocoa solids and/or oil seed meal (e.g., at about 30° C. to about 40° C., or about 35° C.) to homogenize the mixture. The resulting slurry can be pumped into a particle size reduction machine (e.g., a continuous rotor stator particle size reduction machine) by any appropriate means (e.g., a medium/high tip speed with a corrugated barrel). The material can optionally be homogenized, and additional ingredients (if any) can be added. The mixture can then be pumped onto a refiner to reduce the particle size of the material to less than about 30 microns (e.g., less than about 25 microns, or less than about 20 microns). The material then can be conveyed to a liquefier or conch to create the final texture. The chocolate optionally can be tempered, and then can be solidified at a temperature of about 5° C. to about 20° C. (e.g., about 10° C. to about 15° C.) in molds or on a belt slab, for example. The chocolate then can be de-molded and optionally packed or wrapped (e.g., for further processing or use as an industrial ingredient). For further processing, the chocolate can be melted at an elevated temperature (e.g., greater than about 25° C., greater than about 30° C., or greater than about 35° C.). The melted chocolate can be tempered to obtain a desired fat crystal structure, and then placed into molds (e.g., bar molds) and cooled (e.g., at about 5° C. to about 20° C., or about 10° C. to about 15° C.), or deposited onto a cooling belt to produce chips or chunks.

In some cases, a filler (e.g., a grapeseed filler) can be mixed with one or more sugars, cocoa butter (and/or CBE), and optionally cocoa solids and/or seed meal (e.g., at about 30° C. to about 40° C., or about 35° C.) to homogenize the mixture. The resulting slurry can be pumped into, for example, a 2-roll prefine followed by a homogenizing screw, and the material can be homogenized along with additional ingredients, if any. The mix can be conveyed directly onto a refiner to reduce the particle size of the material to less than about 30 microns (e.g., less than about 25 microns, or less than about 20 microns). The material can be conveyed to a liquefier or conch to create the final texture. In some cases, the material can be pumped into a ball mill (e.g., a continuous ball mill) for further particle size reduction. The resulting chocolate optionally can be tempered, and then can be solidified at a temperature of about 5° C. to about 20° C. (e.g., about 10° C. to about 15° C.) in molds or on a belt slab, for example. The chocolate then can be de-molded and optionally packed or wrapped (e.g., for further processing or use as an industrial ingredient). For further processing, the chocolate can be melted at an elevated temperature (e.g., greater than about 25° C., greater than about 30° C., or greater than about 35° C.). The melted chocolate can be tempered to obtain a desired fat crystal structure, and then placed into molds (e.g., bar molds) and cooled (e.g., at about 5° C. to about 20° C., or about 10° C. to about 15° C.), or deposited onto a cooling belt to produce chips or chunks. In some cases, the methods provided herein can be used to produce chocolate beans. For example, a filler having a particle size of about 20 to about 150 μm can be combined with cocoa butter, sugar, and optionally cocoa solids (e.g., with mixing and additional steps as described above). In some cases, a tableting aid (e.g., one or more grain or non-grain ingredients that can aid in tableting, such as a binding agent like a starch, a sugar, and/or a gum) can be added. The mixture can then be tableted (e.g., in a pill press or similar apparatus) to form chocolate beans. Optionally, the chocolate beans can be coated with, for example, shellac, zein protein, or wax.

It is to be noted that in any of the methods for making the compositions provided herein, a chocolate containing a filler (e.g., a grapeseed filler or berry seed filler), cocoa butter (or CBE), and sugar can be generated and then optionally combined with a “traditional” chocolate that contains cocoa butter, sugar, and cocoa solids. In such methods, a portion of the cocoa solids (e.g., about 0.1% to about 75% by weight, such as about 0.1% to about 0.5% by weight, about 0.5% to about 1% by weight, about 1% to about 3% by weight, about 3% to about 5% by weight, about 5% to about 10% by weight, about 10% to about 15% by weight, about 15% to about 20% by weight, about 20% to about 25% by weight, about 25% to about 30% by weight, about 30% to about 40% by weight, about 40% to about 50% by weight, about 50% to about 60% by weight, or about 60% to about 75% by weight) in the traditional chocolate can be replaced by the filler.

In some cases, a chocolate formulation can include appropriate percentages of a filler provided herein, one or more sugars, and one or more fats (e.g., cocoa butter and/or a cocoa butter replacement, substitute, or equivalent, and/or optionally an oilseed meal, and/or lecithin). In some cases, a chocolate formulation can include an appropriate percentage of an oilseed meal (e.g., sunflower meal), such as when using a higher percentage of the filler product. In some cases, a chocolate formulation can include 0-30% by weight of the seed meal, 0-20% by weight of the seed meal, or 7-20% by weight of the seed meal. In some cases, a chocolate formulation can include 10-20 wt % filler, 30-55 wt % sugar, 25-45 wt % cocoa butter substitute, 7-20 wt % seed meal, and 0.25-0.75 wt % lecithin.

Oilseed meals, also commonly referred to as seed meals, are by-products from the production of oils consumed by humans. This group includes rapeseed meal, canola meal, cottonseed meal, flaxseed meal, sunflower meal, and camelina (wild flax) meal. In some cases, one or more cocoa butter replacements, substitutes, and/or equivalents (CBEs) can replace some or all of the cocoa butter in a composition. Cocoa butter replacements, substitutes, and equivalents include, for example, other vegetable fat sources and hardstock fats (fats that are solid at room temperature). Examples of such vegetable fat sources and hardstock fats include, without limitation, shea, illipe, palm oil, sal (Shorea robusta), kokum gurgi (Garcinia indica), mango kernel (Mangifera indica), coconut, oil blends, fractionated oils, and/or interesterified oils. In some cases, a vegetable fat can include two or more hardstock fats blended together (e.g., a 50%:50% blend of palm oil:shea oil). In some cases, a vegetable fat can include one or more cocoa butter equivalents blended together with cocoa butter (e.g., a 75%:25% blend of palm oil:cocoa butter) to provide some of the flavor and aroma characteristics of cocoa butter without the expense of pure cocoa butter. In some cases, a vegetable fat can include one or more hardstock fats blended with one or more liquid vegetable oils to create a blended fat (e.g., a 75%:25% blend of palm oil:rapeseed oil). In some cases, a blend of a hardstock fat and an oil that is liquid at room temperature can yield a blended product with some of the desired characteristics of a pure hardstock fat.

In some embodiments, the whole seeds described herein are cleaned with equipment such as a destoner, a scalping deck, an aspiration channel, a sizing deck, an optical sorter, a sieve, or a combination thereof. For example, a destoner can separate particles based on density and remove heavier impurities, e.g., rocks and glasses; a scalping deck can separate particles by size and remove larger impurities, e.g., large sticks; an aspiration channel can be used to blow air to further clean the material such as stems that may not be completely removed by other equipment (e.g., the destoner and scalping deck); a sizing deck is similar to a scalping deck but can use smaller or larger screens to obtain only the material with a desired size; a sieve is also similar but often used to remove chaff or dust; an optical sorter can be used for a combination of the purposes discussed above, which uses highly sophisticated optical imaging to target impurities that can be removed from the product with compressed air.

In some embodiments, the whole seeds described herein are treated chemically and/or enzymatically either simultaneously or in series (e.g., with a chemical solution or a solution containing enzymes). The whole seeds may be treated with a chemical solution containing, without limitation, a caustic agent, an acidulant, or an oxidizing agent such as hydrogen peroxide. Acidulants can include, without limitation, acetic, adipic, citric, fumaric, lactic, malic, phosphoric and tartaric acids, and/or glucono-delta-lactone. The whole seeds can be treated enzymatically with one or more enzymes previously described (e.g., cellulase, tannase, pectinase, xylase, or hemicellulose). When the treatment entails a chemical method with a caustic solution, the caustic agent can be, for example, sodium hydroxide, potassium hydroxide, sodium carbonate, calcium carbonate, calcium hydroxide, potassium bicarbonate, or iodine, which can be applied to the whole seeds at ambient or at an elevated temperature and/or under atmospheric pressure or at an elevated pressure above atmosphere. The treatment can occur through various methods, including soaking, spraying, boiling, agitating, coating, or a combination of these methods to expose whole seeds and/or their hulls to the chemical and/or enzymatic agents. In some embodiments, the whole seeds are treated with the chemical and/or enzymatic agents in aqueous solution at an elevated temperature (e.g., 75° C. to 100° C.) with agitation for 30 minutes to 2 hours, to reach a pH of 8-10.

In some embodiments, the seeds and/or solids described herein can be ground by one or more dry milling techniques and/or one or more wet milling techniques, including, without limitation, grinding through the use of a wet mill, a crushing mill, a burr mill, an espresso grinder, a stone mill, a jet mill, a burr mill, a roller mill, a pin mill, an air classifier mill, a hammer mill, a colloid mill (if fat or liquid has been added to dry material), a corundum mill, a stone mill, a blade mill, or a high impact mill. Dry milling is used for grinding dry materials low in oil and/or moisture and is also useful for coarse grinding into fragments or larger particles. Dry grinding can also be used to reduce particle sizes down to about 100 μm.

Wet milling (wet grinding technique) can be used to reduce particle size and is capable of grinding down material (e.g., roasted grapeseeds or roasted fruit seeds) to a refined paste, in some cases, below 100 μm, in some cases, below about 40 μm, in some cases below 35, μm, or in some cases, about 25 μm. Examples of wet milling grinders include, without limitation, colloid mills, corundum mills, stone mills, and blade mills. Wet milling is performed by adding a liquid medium such as water or liquid oil to act as a lubricator during the milling process. Depending on whether the final product is a water-based or fat-based product, either water or fat/oil may be added for wet milling. For producing the fat-based chocolate products of the present invention, fat or liquid oil (e.g., cocoa butter or a cocoa butter equivalent) is added to the seeds pre-grinding, then ground in the fat to enable finer particle sizes. Some advantages of wet milling include the reduction of explosion risk at finer final particle sizes, lower capital investment, and ease of grinding effectiveness for a wider array of materials, particularly when the material that is ground, such as grape seeds, contain inherent oil (i.e., grape seed oil). Wet milling is a particularly effective technique for grinding oil-containing seeds such as grape seeds and fruit seeds after they are roasted to produce a filler having a reduced particle size. In some embodiments, 30-60% by weight of a fat or liquid oil is added to roasted grape seeds and wet milled in the fat/oil medium to produce wet milled grape or fruit seeds for the fillers and compositions of the present invention, for example, by grinding with a stone mill (e.g., stone melanger), a colloid mill, a blade mill, or a corundum mill.

### EXEMPLARY EMBODIMENTS

Embodiment 1 is a composition consisting essentially of roasted and ground fruit seeds, wherein the ground fruit seeds have a particle size less than 350 microns.

Embodiment 2 is the composition of embodiment 1, wherein the fruit seeds are grape seeds.

Embodiment 3 is the composition of embodiment 2, wherein the grape seeds are from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, or grenache blanc grapes.

Embodiment 4 is the composition of embodiment 1, wherein the fruit seeds are from cranberry, raspberry, blueberry, strawberry, blackberry, pomegranate, kiwi, watermelon, muskmelon, cantaloupe, honeydew, papaya, passionfruit, starfruit, tomato, tomatillo, dragon fruit, guava, soursop, calamansi, pumpkin, squash, okra, cucumber, bell pepper, eggplant, pears, apples, cherimoya, pineapple, quince, lingonberries, date, or fenugreek.

Embodiment 5 is the composition of any one of embodiments 1 to 4, wherein the ground fruit seeds have a particle size less than 250 microns.

Embodiment 6 is the composition of any one of embodiments 1 to 4, wherein the ground fruit seeds have a particle size less than 150 microns.

Embodiment 7 is a consumable product comprising a filler consisting essentially of roasted and ground fruit seeds, wherein the ground fruit seeds have a particle size less than 350 microns.

Embodiment 8 is the consumable product of embodiment 7, wherein the consumable product is a chocolate.

Embodiment 9 is the consumable product of embodiment 8, wherein the chocolate comprises about 0.01% to about 35% by weight of the filler; about 20% to about 55% by weight cocoa butter; about 20% to about 60% by weight sugar; and optionally about 0.5% to about 25% by weight cocoa solids.

Embodiment 10 is the consumable product of embodiment 8, wherein the chocolate comprises: about 17.5% by weight of the filler; about 37.5% by weight cocoa butter; about 40% by weight sugar; and optionally about 5% by weight cocoa solids.

Embodiment 11 is the consumable product of any one of embodiments 7 to 10, wherein the fruit seeds are grape seeds.

Embodiment 12 is the consumable product of embodiment 11, wherein the grape seeds are from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, or grenache blanc grapes.

Embodiment 13 is the consumable product of any one of embodiments 7 to 10, wherein the fruit seeds are from cranberry, raspberry, blueberry, strawberry, blackberry, pomegranate, kiwi, watermelon, muskmelon, cantaloupe, honeydew, papaya, passionfruit, starfruit, tomato, tomatillo, dragonfruit, guava, soursop, calamansi, pumpkin, squash, okra, cucumber, bell pepper, eggplant, pears, apples, cherimoya, pineapple, quince, lingonberries, date, or fenugreek.

Embodiment 14 is the consumable product of any one of embodiments 7 to 13, wherein the ground fruit seeds have a particle size less than 250 microns.

Embodiment 15 is the consumable product of any one of embodiments 7 to 13, wherein the ground fruit seeds have a particle size less than 150 microns.

The invention will be further described in the following examples, which do not limit the scope of the invention described in the claims.

### EXAMPLES

### Example 1—Seed Material Processing (Changing pH as a Solution)

Seed material was processed according to the following procedure:
1. Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To determine impurities, one kilogram sample of cleaned whole seeds were visually inspected and hand-sorted to remove chaff, broken material, and other products that were not removed during the cleaning process. This resulted in two hand-sorted samples, which were weighed. The impurities were reported as a percent of the cleaned sample.
2. The whole seeds were treated with a caustic solution (e.g., sodium hydroxide, potassium hydroxide, sodium carbonate, calcium carbonate, calcium hydroxide, potassium bicarbonate, hydrogen peroxide, or iodine) in water at an elevated temperature (e.g., 75° C. to 100° C.) with agitation for 30 minutes to 2 hours, to reach a pH of 8-10. It was observed that a rise in pH is a function of both the temperature and the length of time that the seeds were agitated in the caustic solution; treating the whole seeds in the caustic solution at a temperature in the higher end of the range, 75° C. to 100° C., and/or for a length of time in the higher end of the range, 30 minutes to 2 hours, resulted in a pH at the higher end of the range, 8-10. In conjunction with, or either before or after treatment with a caustic solution, in some examples, the whole seeds were treated enzymatically with a solution containing enzymes (e.g., cellulases and/or hemicellulases) in aqueous solution with agitation for 30 minutes to 2 hours. The enzymes were observed to help in the breakdown of the tough, lignan-heavy, fibrous material of the grape seeds or fruit seeds.
3. The seeds were either sieved and the two resulting streams were dried separately, and/or a vacuum was used to suction away liquid, and moisture was evaporated from the slurry. The target moisture content after drying was between 2 and 10% w/w, preferably 6% w/w. When a vacuum was pulled on the slurry itself, the target moisture content was less than 25% w/w (preferably 20% w/w). Moisture content was measured using a moisture balance based on the loss on drying method. A wet sample was weighed on a balance, placed in an oven, and heated until the end of the drying period, i.e., until the sample reaches equilibrium. The weight loss is the moisture content of the sample.
4. The seeds and solids from step 3 were roasted for about 20 minutes to 2 hours (e.g., about 45 minutes) using convection, conduction, or a combination of the two at 140-200° C., and preferably 150-175° C. After roasting was completed, it was observed that the seeds had turned a dark brown color and produced coffee-like sensory notes. A dark brown color was particularly noticeable upon roasting of seeds that had been pH adjusted to a pH in the higher end of the range of 8-10 in step 2. The target moisture content after roasting was less than 2% w/w. Moisture content was measured using a moisture balance based on the loss on drying method. A wet sample was weighed on a balance, placed in an oven, and heated until the end of the drying period, i.e., until the sample reaches equilibrium. The weight loss is the moisture content of the sample.
5. The seeds and other solids from the roasting step were ground to a refined paste having a particle size of 350 μm or less (preferably 150 μm or less) using a mill (e.g., a wet mill, a crushing mill, a burr mill, an espresso grinder, a stone mill, or a jet mill), and optionally sifted to remove unwanted material. For example, after mill grinding, sifting with a sieve or mesh allowed for removal of any larger particles or foreign material (e.g., leaf or stem) that had passed through the earlier seed material processing steps inadvertently. For some wet milling examples, a fat or liquid oil (e.g., a vegetable fat such as cocoa butter or a cocoa butter equivalent) was added to the seeds pre-grinding, then ground to a paste. The fat was added in the amount of 30-60% by weight to the roasted grape seeds and wet milled to produce the wet milled grapeseed in a paste form. Wet milling was performed on a stone mill (e.g., stone melanger), a colloid mill, a blade mill, or a corundum mill.

### Example 2—Seed Material Processing (Changing pH as a Dispersion)

Seed material was processed according to the following procedure:
1. Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To measure impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample.
2. Under agitation, the whole seeds were sprayed with a caustic solution (e.g., sodium hydroxide, potassium hydroxide, sodium carbonate, calcium carbonate, calcium hydroxide, potassium bicarbonate, hydrogen peroxide, or iodine) at an elevated temperature (e.g., 60° C. to 125° C.), with mixing to disperse and coat each seed until a pH of 5.5 to 10.5 was reached. It was observed that a rise in pH is a function of both the temperature and the length of time that the seeds were agitated with the caustic solution; treating the whole seeds with the caustic solution at a temperature in the higher end of the range, 60° C. to 125° C., and/or for a length of time in the higher end of the range, 30 minutes to 2 hours, resulted in a pH at the higher end of the range, 5.5-10.5. In conjunction with, or either before or after treatment with a caustic solution, in some examples, the whole seeds were treated enzymatically with a solution containing enzymes (e.g., cellulases and/or hemicellulases) in aqueous solution with agitation for 30 minutes to 2 hours. The enzymes were observed to help in the breakdown of the tough, lignan-heavy, fibrous material of the grape seeds or fruit seeds. The temperature was increased to evaporate water and dry the seeds, optionally under vacuum. The target moisture content at the end of this step was less than 25% w/w moisture. Moisture content was measured using a moisture balance based on the loss on drying method. A wet sample was weighed on a balance, placed in an oven, and heated until the end of the drying period, i.e., until the sample reaches equilibrium. The weight loss is the moisture content of the sample.
3. The seeds were roasted using convection, conduction, or a combination of the two at 140-200° C., and preferably 150-175° C. The target moisture content was less than 2% w/w. Moisture content was measured using a moisture balance based on the loss on drying method. A wet sample was weighed on a balance, placed in an oven, and heated until the end of the drying period, i.e., until the sample reaches equilibrium. The weight loss is the moisture content of the sample. For example, the dried seeds were roasted in a convective roaster at a temperature of 140° C. to 200° C. for between 20 minutes to 2 hours, resulting in roasted seeds. After roasting was completed, it was observed that the seeds had turned a dark brown color and produced coffee-like sensory notes. A dark brown color was particularly noticeable upon roasting of seeds that had been pH adjusted to a pH in the higher end of the pH range in step 2.
4. The seeds and other solids from the roasting step were ground to a refined paste having a particle size of 350 μm or less (preferably 150 μm or less) using a mill (e.g., a wet mill, a crushing mill, a burr mill, an espresso grinder, a stone mill, or a jet mill), and optionally sifted to remove unwanted material. For example, after mill grinding, sifting with a sieve or mesh allowed for removal of any larger particles or foreign material (e.g., leaf or stem) that had passed through the earlier seed material processing steps inadvertently. For wet milling, which is used to further refine a product, a fat or liquid oil (e.g., a vegetable fat such as cocoa butter or a cocoa butter equivalent) was added to the seeds pre-grinding, then ground to a paste. The fat was added in the amount of 30-60% by weight to the roasted grape seeds and wet milled in the fat to produce a wet milled grapeseed in paste form. Wet milling was performed on a stone mill (e.g., stone melanger), a colloid mill, a blade mill, or a corundum mill.

### Example 3—Seed Material Processing (Changing pH in a Reaction Vessel)

Seed material was processed according to the following procedure:
1. Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To measure impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample.
2. Under agitation in the base of a reaction chamber, a caustic solution (e.g., sodium hydroxide, potassium hydroxide, sodium carbonate, calcium carbonate, calcium hydroxide, potassium bicarbonate, hydrogen peroxide, or iodine) was applied to the whole seeds using a solution with just enough water to fluidize the seeds, until a pH of 5.5 to 10.5 was reached. It was observed that a rise in pH is a function of both the temperature and the length of time that the seeds were agitated in the caustic solution; treating the whole seeds in the caustic solution at a temperature in the higher end of the range, 75° C. to 100° C., and/or for a length of time in the higher end of the range, 30 minutes to 2 hours, resulted in a pH at the higher end of the range, 5.5-10.5. In conjunction with, or either before or after treatment with a caustic solution, in some examples, the whole seeds were treated enzymatically with a solution containing enzymes (e.g., cellulases and/or hemicellulases) in aqueous solution with agitation for 30 minutes to 2 hours. The enzymes were observed to help in the breakdown of the tough, lignan-heavy, fibrous material of the whole seeds.
3. Steam and/or pressure was used to heat the material and accelerate the pH adjustment process at an elevated pressure of 1-3 bar above atmosphere for 10 minutes to 2 hours. The application of steam with elevated pressure (or steam without elevated pressure), when used, reduced the amount of time required to effect a change in observed pH of the whole seed reaction mixture and treated seeds to between 5.5 and 10.5. In an optional variation of this step, the pH adjustment process was performed with steam but without the addition of elevated pressure above atmospheric pressure. In another optional variation of this step, the pH adjustment process was performed without the addition of steam and at atmospheric pressure. All three variations of this step resulted in treated seeds with an observed pH of between 5.5 and 10.5.
4. Once the pH adjustment step was completed, vacuum suction (pulling) was optionally used to aspirate the solution and to partially dry the seeds. The application of vacuum suction produced a reduction in moisture content and resulted in a moisture content at the end of this step of less than 25% w/w moisture, and less than 20% w/w moisture. The target moisture content at the end of this step is less than 25% w/w moisture, and preferably less than 20% w/w moisture. Moisture content was measured using a moisture balance based on the loss on drying method. A wet sample was weighed on a balance, placed in an oven, and heated until the end of the drying period, i.e., until the sample reaches equilibrium. The weight loss is the moisture content of the sample. When no vacuum suction was used, the wet seeds were partially dried by application of low heat at a slightly elevated temperature between 120-160° F.
5. The seeds were roasted using convection, conduction, or a combination of the two at 140-200° C., and preferably 150-175° C. The target moisture content after roasting was less than 2% w/w.
6. The roasted seeds and other solids from the roasting step were ground to a refined paste having a particle size of 350 μm or less (preferably 150 μm or less) using a mill (e.g., a wet mill, a crushing mill, a burr mill, an espresso grinder, a stone mill, or a jet mill) and optionally sifted to remove unwanted material. For wet milling, a fat or liquid oil (e.g., a vegetable fat such as cocoa butter or a cocoa butter equivalent) was added to the seeds pre-grinding, then ground to a paste. The fat was added in the amount of 30-60% by weight to the roasted grape seeds and wet milled in the fat to produce the wet milled grapeseed in a paste form. Wet milling was performed on a stone mill (e.g., stone melanger), a colloid mill, a blade mill, or a corundum mill.

### Example 4—Seed Material Processing (Changing pH in Roaster)

Seed material was processed according to the following procedure:
1. Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). the target impurity at the end of the cleaning process was less than 0.5 w/w %. To measure impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample.
2. Under agitation, the whole seeds were sprayed with a caustic solution (e.g., sodium hydroxide, potassium hydroxide, sodium carbonate, calcium carbonate, calcium hydroxide, potassium bicarbonate, hydrogen peroxide, or iodine) at an elevated temperature (e.g., 60° C. to 125° C.), and mixed to disperse and coat each seed until a pH of 5.5 to 10.5 was reached. It was observed that a rise in pH is a function of both the temperature and the length of time that the seeds were agitated with the caustic solution; treating the whole seeds with the caustic solution at a temperature in the higher end of the range, 60° C. to 125° C., and/or for a length of time in the higher end of the range, 30 minutes to 2 hours, resulted in a pH at the higher end of the range, 5.5-10.5. In conjunction with, or either before or after treatment with a caustic solution, in some examples, the whole seeds were treated enzymatically with a solution containing enzymes (e.g., cellulases and/or hemicellulases) in aqueous solution with agitation for 30 minutes to 2 hours. The enzymes were observed to help in the breakdown of the tough, lignan-heavy, fibrous material of the grape seeds or fruit seeds. The temperature and air speed were increased to evaporate water and dry the seeds.
3. The seeds were placed in a convective/conductive roaster.
4. Once the seeds were dry, the roasting temperature was increased above 125° C. (e.g., up to 200° C.). The seeds were roasted using convection, conduction, or a combination of the two. For example, the dried seeds were roasted in a convective roaster at a temperature of 140° C. to 200° C. for between 20 minutes to 2 hours, resulting in roasted seeds. After roasting was completed, it was observed that the seeds had turned a dark brown color and produced coffee-like sensory notes. A dark brown color was particularly noticeable upon roasting of seeds that had been pH adjusted to a pH in the higher end of the pH range in step 2.
5. The seeds and other solids from the roasting step were ground to a refined paste having a particle size of 350 μm or less (preferably 150 μm or less) using a mill (e.g., a wet mill, a crushing mill, a burr mill, an espresso grinder, a stone mill, or a jet mill) and optionally sifted to remove unwanted material. For some wet milling examples, a fat or liquid oil (e.g., a vegetable fat such as cocoa butter or a cocoa butter equivalent) was added to the seeds pre-grinding, then ground to a paste. The fat was added in the amount of 30-60% by weight to the roasted grape seeds and wet milled in the fat to produce the wet milled grapeseed in a paste form. Wet milling was performed on a stone mill (e.g., stone melanger), a colloid mill, a blade mill, or a corundum mill.

### Example 5—Seed Material Processing (Reacting Agents During Dutching/Roasting)

Seed material was processed according to the following procedure:
1. Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To measure impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample.
2. Under agitation, the seeds were sprayed with a caustic solution (e.g., sodium hydroxide, potassium hydroxide, sodium carbonate, calcium carbonate, calcium hydroxide, potassium bicarbonate, hydrogen peroxide, or iodine) with optional reaction ingredients (e.g., sugars, amino acids, transition/catalyst metals, and/or salts) at an elevated temperature (e.g., 60° C. to 150° C.), and mixed to disperse and coat each seed until a pH of 5.5 to 10.5 was reached. For example, the seeds were dutched with a solution to pH 8.5. It was observed that a rise in pH is a function of both the temperature and the length of time that the seeds were agitated with the caustic solution; treating the whole seeds in the caustic solution at a temperature in the higher end of the range, 60° C. to 150° C., and/or for a length of time in the higher end of the range, 30 minutes to 2 hours, resulted in a pH at the higher end of the range, 5.5-10.5. In conjunction with, or either before or after treatment with a caustic solution, in some examples, the whole seeds were treated enzymatically with a solution containing enzymes (e.g., cellulases and/or hemicellulases) in aqueous solution with agitation for 30 minutes to 2 hours. The enzymes were observed to help in the breakdown of the tough, lignan-heavy, fibrous material of the grape seeds. The temperature and air speed were increased to evaporate water and dry seeds.
3. The seeds were placed in a convective/conductive roaster.
4. Once dry, the roasting temperature was increased above 125° C. (e.g., up to 200° C.) and the seeds were roasted using convection, conduction, or a combination of the two. For example, the dried seeds were roasted in a convective roaster at a temperature of 140° C. to 200° C. for between 20 minutes to 2 hours, for instance, at 380° F. for 30 minutes, resulting in roasted seeds. After roasting was completed, it was observed that the seeds had turned a dark brown color and produced coffee-like sensory notes. A dark brown color was particularly noticeable upon roasting of seeds that had been pH adjusted to a pH in the higher end of the pH range in step 2.
5. The seeds and other solids from the roasting step were ground to a particle size of 350 μm or less (preferably 150 μm or less) using a mill (e.g., a wet mill, a crushing mill, a burr mill, an espresso grinder, a stone mill, or a jet mill) and optionally sifted to remove unwanted material. For wet milling, a fat or liquid oil (e.g., a vegetable fat such as cocoa butter or a cocoa butter equivalent) was added to the seeds pre-grinding, then ground to a paste. The fat was added in the amount of 30-60% by weight to the roasted grape seeds and wet milled in the fat to produce the wet milled grapeseed in a paste form. Wet milling was performed on a stone mill (e.g., stone melanger), a colloid mill, a blade mill, or a corundum mill.

### Example 6—Seed Material Processing (Roasting)

Seed material was processed according to the following procedure:
1. Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To measure impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample.
2. After the cleaning step, the seeds were placed in a convective/conductive roaster to begin the drying process.
3. Under agitation, the seeds were heated with convection and/or conduction to evaporate water and dry the seeds. The temperature and air speed (if used) were increased to facilitate this process.
4. Once the seeds contained <5% w/w moisture, the roasting temperature was increased above 125° C. (e.g., up to 200° C.). The seeds were roasted using convection, conduction, or a combination of the two. For example, the dried seeds were roasted in a convective roaster at a temperature of 140° C. to 200° C. for between 20 minutes to 2 hours, resulting in roasted seeds. After roasting was completed, it was observed that the seeds had turned a dark brown color and produced coffee-like sensory notes.
5. The seeds and other solids from the roasting step were ground to a particle size of 350 μm or less (preferably 150 μm or less) using a mill (e.g., a wet mill, a crushing mill, a burr mill, an espresso grinder, a stone mill, or a jet mill) and optionally sifted to remove unwanted material. For wet milling, a fat or liquid oil (e.g., a vegetable fat such as cocoa butter or a cocoa butter equivalent) was added to the seeds pre-grinding, then ground to a paste. The fat was added in the amount of 30-60% by weight to the roasted grape seeds and wet milled in the fat to produce the wet milled grapeseed in a paste form. Wet milling was performed on a stone mill (e.g., stone melanger), a colloid mill, a blade mill, or a corundum mill.

### Example 7—Preparing a 60% Chocolate Product

A chocolate was prepared using methods standard for most small bean to bar chocolates. Raw, winnowed (shells removed) cocoa nibs of Peruvian origin were roasted 100 g at a time in a high convection oven for 7 minutes at 300° F. The formula was based on the 60.1% standard Barry Callebaut chocolate, which has high consumer acceptance and available compositional data. The recipe included, by weight:
22.7% fat free cocoa solids
37.4% cocoa butter
39.9% sugar

Based on data indicating how much fat was in the cocoa nibs, the formula was determined to have the following composition (by weight):
45.4% roasted nibs
14.7% additional cocoa butter (standard)
39.3% sugar (standard granulated)

The formula was blended together and ground for 16 hours using a stone melanger (CocoaTown; Alpharetta, GA) with the pressure set to “high.” The final particle size was 25 microns.

A grapeseed version of the chocolate (“grapeseed chocolate”) was created with the following composition to mimic the pure chocolate formula, based on solids information:
22.7 wt % grapeseed (dutched as a solution to pH 8.5, dried and roasted at 380° F. for 30 minutes)
37.4 wt % cocoa butter
39.9 wt % sugar

The formula was blended together and ground for 48 hours using a stone melanger (Cocoatown) with the pressure set to “high.” Due to the harder seed material, the grape seed chocolate required more grinding action to create a similar particle size. The final particle size ranged from 25 to 35 microns. The particle size was measured using a micrometer screw and also a Hegman gauge multiple times during the grinding process for both the control chocolate and the grapeseed chocolate and readings confirmed a mean particle size of about 25 microns for both the control and the grapeseed chocolate.

Because the chocolates were created to be the same compositionally, the grapeseed chocolate was mixed with the “real” chocolate at a ratio of 3:1, resulting in a solids makeup of 75% grape seed and 25% cocoa by weight. Thus, 75% replacement of the cocoa solids (by weight) were replaced by the grape seed.

The chocolate was tempered and molded into bars by hand, followed by full cooling and release of the chocolate from the molds. The chocolate bars were sensory tested at room temperature using the protocol described in Example 8.

### Example 8—Sensory Testing

A panel consisting of five trained descriptive panelists was utilized for a sensory evaluation of the chocolate containing the grape seed filler as compared to chocolate without the grape seed filler. The Flavor Profile Method (FPM; International Organization for Standardization (ISO) 6564; Details can be found at: https://www.iso.org/standard/12966.html) was used to assess the intensity of chocolate aroma and flavor in the 60% chocolate/grapeseed product (by weight). The panel members individually evaluated products and then worked in discussion as a group to determine a consensus profile. If a consensus was not obtained, it was not possible to refer to reference substances to aid the group in reaching an agreement. For the conditions in the room in which the tests were conducted, see ISO 6658 (Details can be found at: https://www.iso.org/standard/65519.html). The 7 point scale that was utilized included scores ranging from 0-3, as laid out in TABLE 1 below.

TABLE 1
Sensory Scoring Levels

| Number | Intensity |
|---|---|
| 0 | None |
| 0.5 | Very Slight |
| 1 | Slight |
| 1.5 | Slight to Moderate |
| 2 | Moderate |
| 2.5 | Moderate to Strong |
| 3 | Strong |

When the composite results were compiled, these studies demonstrated that the 60% chocolate and the 75% grapeseed replacement products (by weight) had the same sensory characteristics (TABLE 2).

TABLE 2
Composite Sensory Scores

| | 60% | 75% | | 60% | 75% |
|---|---|---|---|---|---|
| | Choc- | Grape- | | Choc- | Grape- |
| Aroma | olate | seed | Flavor | olate | seed |
| Chocolate | 1.5 | 1.5 | Chocolate | 2 | 2 |
| Wax | 1 | 1 | Bitter | 1 | 1 |
| Resinous | 0.5 | 0.5 | Sweet | 1.5 | 1.5 |
| Fruity Sweet | 1 | 1 | Powdery/gritty | 1 | 1 |
| Dusty | 0.5 | 0.5 | Dusty/chalky | 1 | 1 |
| Plantain | 0.5 | 0.5 | Astringent (mouth | 1 | 1 |
| | | | puckering) | | |
| Plastic/latex | 0.5 | 0.5 | Dried fruit | 0.5 | 0.5 |
| | | | (raisin/date) | | |
| Berry | 0.5 | 0.5 | Smokey | 0.5 | 0.5 |
| Roast | 0.5 | 0.5 | Roasted | 0.5 | 0.5 |
| Coconut | 0.5 | 0.5 | Drying | 1 | 1 |
| dried | | | | | |
| Vanilla | 0.5 | 0.5 | Sandpaper | 1.5 | 1.5 |
| | | | Creamy | 1 | 1 |
| | | | mouthfeel | | |
| | | | Vanilla woody | 0.5 | 0.5 |

Thus, these data indicated that replacement of up to 75% of the cocoa solids with grapeseed filler had a favorable sensory result.

### Example 9—Viscosity Testing (Production Enhancement)

The studies described above demonstrated that replacement of 75% of the cocoa solids (by weight) with the grape seed filler did not yield a difference in flavor. Further studies demonstrated that the replacement of a smaller percentage of cocoa solids (2%) also yielded a processing enhancement. Specifically, 2% of the solids in cocoa liquor (by weight) were replaced with grapeseed liquor prepared with cocoa butter.

The liquors were processed using a stone melanger as described above, except that only fat and solids were used. For the cocoa liquor, this meant that the processing mix was nibs alone, as the solids and fat were already present. For the grapeseed liquor, grapeseed was mixed with cocoa butter at an equal solids percentage as the cocoa nibs (47% solids, 53% fat). The liquors yielded equal particle size as measured by a micrometer screw: 25 microns.

The viscosity of the cocoa nib liquor was measured at 100% and at 96% with 4% addition of grapeseed liquor, to yield a 2% cocoa solids replacement. For chocolate, there can be a strong resistance to flow when cocoa butter is present at a lower percentage (closer to that which is found in the cocoa nib). However, increasing the amount of cocoa butter to improve processing may not be ideal due to the high cost of cocoa butter. Other additives (e.g., PGPR) can be used to enhance flow characteristics, but chocolate containing such additives may not be desirable consumers.

Measurements were made using a Bostwick Consistometer and a Zahn Cup (ASTM D4212). The Bostwick Consistometer is an industry standard for measuring flow and consistency. The faster the product runs down the ramp of the consistometer, the less resistance there is to flow. The products were measured at 140° F., and the room was at 71.5° F. The 13 mark on the Bostwick consistometer was used as the point of measure. The time for pure cocoa nib liquor to flow down the ramp was 1:04:06 (mm:ss:ms), while the time for the liquor containing 2% grapeseed solids (by weight) was 00:13:55.

The Zahn Cup (ASTM D4212) is a measure often used in the dairy industry to measure the viscosity of materials. This device is used to measure the time it takes for a material to flow through a cup having a standardized hole drilled through it. The Zahn Cup is similar to the Bostwick test in terms of information, but it gives additional information about the flow of the material for applications (e.g., shell molding) that require chocolate to be thinner in order to create a thin, even shell in the mold. Again, cocoa butter can be increased in order to facilitate these differences in viscosity, but these studies demonstrated that including grapeseed liquor to replace 2% of the cocoa solids (by weight) significantly reduced viscosity. Specifically, when the products were measured at 140° F. in a 71.5° F. room, the time for pure cocoa nib liquor to run through the Zahn cup was 01:34 (mm:ss), while the time for the liquor containing 2% grapeseed solids was 01:17. Thus, the grapeseed liquor was successfully used as a processing aid to improve the flow of the chocolate.

Taken together, the studies described above demonstrated that the use of a grapeseed filler provided herein resulted in chocolate products having characteristics (e.g., taste, aroma, and viscosity) of traditional chocolate, without increasing the cost of production. These results indicate that the grapeseed can be used to replace cocoa solids, providing cost savings, supply chain stabilization, and processing enhancement.

### Example 10—Volatile Organic Compounds (VOCs) in Chardonnay Grapeseed

LC-MS was used to measure the levels of various compounds in chardonnay grapeseed and reference chocolates, according to the following method.

All analyses were performed on a Thermo Ultimate 3000 Ultra-Performance Liquid Chromatograph (UPLC) coupled with a Thermo Scientific Q-Exactive high resolution mass spectrometer (MS). xCalibur software was used for data acquisition, and the mass spectrometer instrument parameters were as follows for all methods:
Polarity: positive or negative mode, as indicated for each method
Resolution: 70,000
Scan range: 60-900 m/z for all methods with the exception of the lipid method, which is 134-2000 m/z
Isolation window: 1.5 m/z
MS/MS collision energy: 30

Preparation of analytical standards: Stock solutions at a concentration of 1 mg/mL were made for each compound in 50% methanol. Serial dilutions were then made of each compound to create a 15-point standard curve, ranging from 10 ng/mL to 20 μg/mL. Standard curves were run in combinations of 7-12 compounds from each category per set, so long as there were no overlaps in retention time, which would have hindered quantitation. Retention times were pre-determined for each compound by running the analytical standard at a 20 μg/mL dilution, and identifying the compound based on its accurate mass. In all cases, five μL of each standard mix was injected through the autosampler and LC to the MS. Separation took place on a chromatographic column that was specific to each class of compounds. The conditions for each chromatographic method are described below, including the column, mobile phase and gradient used for each method.

Several types of columns were used for the different compounds, and different limits of detection (LODs) as indicated in TABLES 3A-D.

TABLE 3A
List of compounds quantified by each method in Round 1 assays

| HILIC positive | HILIC negative | Omega negative | C18 positive |
|---|---|---|---|
| methionine | rhamnose | tartaric acid | quinic acid |
| histidine | glucose | citric acid | trans-4-hydroxy proline |
| lysine | mannitol | lactic acid | L-citrulline |
| serine | fructose | 3,4-dihydroxybenzoic acid | kynurenic acid |
| leucine | ribose | gallic acid | |
| isoleucine | arabitol | glucuronic acid | |
| phenylalanine | inositol | fumaric acid | |
| aspartic acid | mannose | malic acid | |
| tyrosine | xylose | 2-isopropylmalic acid | |
| glycine | sorbitol | 2-furoic acid | |
| γ-aminobutyric acid | galactose | pyruvic acid | |
| glucosamine | beta-alanine | succinic acid | |
| arginine | citrulline | | |
| valine | | | |
| proline | | | |
| cystine | | | |
| asparagine | | | |
| glutamic acid | | | |
| tryptophan | | | |
| ornithine | | | |
| glutamine | | | |
| threonine | | | |
| carnitine | | | |
| betaine | | | |
| carnosine | | | |
| homoserine | | | |
| pipecolinic acid | | | |

TABLE 3B
LODs for standards being quantified (in
pg/mL, ng/mL, or ug/mL) in Round 1 assays

| Cassette | Compound | LOD | |
|---|---|---|---|
| 10 | Methionine | 500 | pg |
| 10 | Histidine | 10 | ng |
| 10 | Lysine | 10 | ng |
| 10 | Serine | 2 | ng |
| 10 | Leucine | 500 | pg |
| 10 | Phenylalanine | 500 | pg |
| 10 | Aspartic Acid | 5 | ug |
| 10 | Tyrosine | 2 | ng |
| 10 | GABA | 2 | ng |
| 10 | Glucosamine | 50 | ng |
| 11 | Arginine | 10 | ng |
| 11 | Valine | 100 | ng |
| 11 | Proline | 2 | ng |
| 11 | Isoleucine | 10 | ng |
| 11 | Cysteine | 1 | ug |
| 11 | Asparagine | 10 | ng |
| 11 | Glutamic Acid | 10 | ng |
| 11 | Tryptophan | 2 | ng |
| 11 | Ornithine | 10 | ng |
| 11 | Glutamine | 10 | ng |
| 11 | Threonine | 10 | ng |
| 11 | Carnitine | 500 | pg |
| 12 | Tartaric Acid | 100 | pg |
| 12 | Citric Acid | 10 | ng |
| 12 | 2-Isopropylmalic | 100 | pg |
| | Acid | | |
| 12 | Lactic Acid | 2 | ng |
| 12 | 3,4-dihydroxybenzoic | 100 | pg |
| | Acid | | |
| 12 | Gallic Acid | 500 | pg |
| 12 | D-Glucuronic Acid | 100 | pg |
| 12 | Fumaric Acid | 500 | pg |
| 12 | malic Acid | 100 | pg |
| 12 | 2-Furoic Acid | 10 | ng |
| 12 | Pyruvic Acid | 100 | pg |
| 12 | Succinic Acid | 500 | pg |
| 13 | Rhamnose | 10 | ng |
| 13 | Glucose | 100 | ng |
| 13 | Mannitol | 2 | ng |
| 13 | Fructose | 2 | ng |
| 13 | Ribose | 10 | ng |
| 13 | Arabitol | 2 | ng |
| 15 | Inositol | 10 | ng |
| 15 | Mannose | 10 | ng |
| 15 | Xylose | 100 | ng |
| 15 | Sorbitol | 2 | ng |
| 15 | Galactose | 10 | ng |
| 16 | Quinic Acid | 1 | ng |
| 17 | Trans-4-hydroxy proline | 200 | pg |
| 17 | L-citrulline | 200 | pg |
| 17 | Kynurenic Acid | 200 | pg |

TABLE 3C
Additional LODs for standards being quantified

| Compound | LOD | |
|---|---|---|
| beta alanine | 100 | ppb |
| citrulline | 100 | ppb |
| betaine | <10 | ppb |
| carnosine | <10 | ppb |
| cystine | <100 | ppb |
| D-glucuronic acid | 500 | ppt |
| homoserine | <10 | ppb |
| myo-inositol | 50 | ppb |
| pipecolinic acid | <10 | ppb |
| glycine | 50 | ppb |

TABLE 3D
Methods and LODs for compounds detected

| Compound Name | Method | LOD | |
|---|---|---|---|
| 2(5H)-furanone | C18 Positive | 50 | ppb |
| 2,3,5,6-tetramethylpyrazine | C18 Positive | <1 | ppb |
| 2,3,5-trimethylpyrazine | C18 Positive | <1 | ppb |
| 2,3-dimethylpyrazine | C18 Positive | <1 | ppb |
| 2-ethyl-2-hydroxybutyric acid | Synergi Neg | <10 | ppb |
| 2-furoic acid | Synergi Neg | 10 | ng |
| 2-isopropylmalic acid | Synergi Neg | 100 | pg |
| 3,4-dihydroxybenzoic acid | Synergi Neg | 100 | pg |
| 4-guanidinobutyric acid | C18 Positive | 100 | ppt |
| 4-methoxycinnamic acid | Synergi Neg | 1.75 | ppm |
| 5-ethyl-4-hydroxy-2- | C18 Positive | | |
| methyl-3(2H)-furanone | | | |
| acetovanillone | C18 Positive | 1 | ng |
| adenine | C18 Positive | 200 | pg |
| adipic acid | C18 Negative | <10 | ppb |
| AMP | C18 Positive | 10 | ppb |
| arabitol | HILIC neg | 2 | ng |
| arginine | HILIC Pos | 10 | ng |
| asparagine | HILIC Pos | 10 | ng |
| aspartic acid | HILIC Pos | 5 | ug |
| beta-alanine | HILIC neg | 100 | ppb |
| betaine | HILIC Pos | <10 | ppb |
| caffeic acid | C18 Positive | 20 | ng |
| caffeine | C18 Positive | <10 | ppb |
| carnitine | HILIC Pos | 500 | pg |
| carnosine | HILIC Pos | <10 | ppb |
| catechin | C18 Negative | 1 | ng |
| choline | HILIC Positive | 2 | ng |
| cinnamic acid | C18 Positive | 500 | ng |
| citric acid | Omega Neg | 10 | ng |
| citrulline | C18 pos | 100 | ppb |
| CMP | C18 Positive | <10 | ppb |
| coumaric acid | C18 Positive | 4 | ng |
| cysteine | HILIC Pos | 1 | ug |
| cystine | HILIC Pos | <100 | ppb |
| cytidine | C18 Positive | 5 | ppb |
| cytosine | C18 Positive | 100 | ppt |
| D-gluconic acid | Synergi Neg | <10 | ppb |
| DL-hydroxystearic acid | Synergi Neg | 1.75 | ppm |
| ellagic acid | C18 Negative | 1 | ng |
| epicatechin | C18 Negative | 1 | ng |
| epicatechin gallate | C18 Positive | <10 | ppb |
| fructose | HILIC neg | 2 | ng |
| fumaric acid | Synergi Neg | 500 | pg |
| galactose | HILIC neg | 10 | ng |
| gallic acid | Synergi Neg | 500 | pg |
| glucosamine | HILIC Pos | 50 | ng |
| glucose | HILIC neg | 100 | ng |
| glucuronic acid | Synergi Neg | 500 | ppt |
| glutamic acid | HILIC Pos | 10 | ng |
| glutamine | HILIC Pos | 10 | ng |
| glycine | HILIC Pos | 50 | ppb |
| guanine | C18 Positive | 200 | pg |
| hesperetin | C18 Negative | 200 | pg |
| histidine | HILIC Pos | 10 | ng |
| homoserine | HILIC Pos | <10 | ppb |
| inositol | HILIC neg | 50 | ppb |
| isoleucine | HILIC Pos | 10 | ng |
| kynurenic acid | C18 pos | 200 | pg |
| lactic acid | Synergi Neg | 2 | ng |
| leucine | HILIC Pos | 500 | pg |
| lysine | HILIC Pos | 10 | ng |
| malic acid | Synergi Neg | 100 | pg |
| mannitol | HILIC neg | 2 | ng |
| mannose | HILIC neg | 10 | ng |
| methionine | HILIC Pos | 500 | pg |
| methyl gallate | C18 Negative | <10 | pbp |
| methyl-2-pyrrolyl ketone | C18 Positive | <5 | pbp |
| ornithine | HILIC Pos | 10 | ng |
| pantothenic acid | C18 Positive | 0.2 | ng |
| phenylalanine | HILIC Pos | 500 | pg |
| pipecolinic acid | HILIC Pos | <10 | pbp |
| piperine | C18 Positive | <1 | pbp |
| polydatin | C18 Positive | 4 | ng |
| proline | HILIC Pos | 2 | ng |
| propyl gallate | C18 Negative | <10 | pbp |
| pyridine | C18 Positive | <1 | pbp |
| pyridoxine | HILIC Positive | 100 | pg |
| pyruvic acid | Synergi Neg | 100 | pg |
| quercetin | C18 Negative | 1 | ng |
| quinic acid | C18 pos | 1 | ng |
| resveratrol | C18 Negative | 4 | ng |
| rhamnose | HILIC neg | 10 | ng |
| ribose | HILIC neg | 10 | ng |
| rutin | C18 Negative | 1 | ng |
| salicylic acid | C18 Negative | 200 | pg |
| serine | HILIC Pos | 2 | ng |
| sinapinic acid | C18 Negative | 200 | pg |
| sorbic acid | C18 Positive | 100 | ng |
| sorbitol | HILIC neg | 2 | ng |
| sotolon | C18 Positive | 25 | ppb |
| succinic acid | Synergi Neg | 500 | pg |
| syringaldehyde | C18 Positive | 1 | ng |
| syringic acid | C18 Positive | 50 | ng |
| tartaric acid | Synergi Neg | 100 | pg |
| threonine | HILIC Pos | 10 | ng |
| trans-4-hydroxy proline | C18 pos | 200 | pg |
| trans-4-hydroxyproline | HILIC Positive | <10 | ppb |
| trans-ferulic acid | C18 Negative | 1 | ng |
| tryptamine | C18 Positive | 200 | pg |
| tryptophan | HILIC Pos | 2 | ng |
| tyramine | C18 Positive | 1 | ng |
| tyrosine | HILIC Pos | 2 | ng |
| uracil | C18 Positive | 5 | ppb |
| valine | HILIC Pos | 100 | ng |
| vanillic acid | C18 Positive | 10 | ng |
| vanillin | C18 Positive | 200 | pg |
| xylose | HILIC neg | 100 | ng |
| γ-aminobutyric acid | HILIC Pos | 2 | ng |

Quantitation of Amino Acids and Similar Polar Compounds: A HILIC (hydrophilic interaction liquid chromatography) column was used to assess polar compounds that can retain a positive charge (TABLE 4). The mobile phase used with this column included A: H₂O+5 mM Ammonium Acetate+0.1% TFA (trifluoroacetic acid), and B: 90/10 ACN (Acetonitrile)/H₂O+5 mM Ammonium Acetate+0.1% TFA. Each chromatographic run was 27.5 minutes long, and the column temperature was maintained at 40° C. The column used was a Phenomenex Luna, 3 μm NH2, 100 Å, 150×2 mm (Product #00F-4377-B0), and the guard column was a Phenomenex Security Guard Cartridges, NH2, 4×2 mm (#PRD-196870).

TABLE 4
HILIC positive mode gradient conditions

| Time | Flow Rate (mL/min) | % A | % B |
|---|---|---|---|
| 0 | 0.5 | 5 | 95 |
| 6 | 0.5 | 5 | 95 |
| 18 | 0.5 | 60 | 40 |
| 20 | 0.5 | 80 | 20 |
| 22 | 0.5 | 5 | 95 |
| 27 | 0.5 | 5 | 95 |

Quantitation of Sugars and Sugar Alcohols: The same HILIC column used for quantitation of the amino acids was used for quantitation of sugars, but the polarity of the MS was run in negative mode (TABLE 5). While the same mobile phases were used, the gradient was slightly modified to help with retention. The temperature of the column also was held at 50° C. for better peak shape and separation of the isobaric sugars.

TABLE 5
HILIC negative mode gradient conditions

| Time | Flow Rate (mL/min) | % A | % B |
|---|---|---|---|
| 0 | 0.5 | 0 | 100 |
| 3 | 0.5 | 0 | 100 |
| 18 | 0.5 | 18 | 82 |
| 19 | 0.5 | 26 | 74 |
| 20 | 0.5 | 60 | 40 |
| 21 | 0.4 | 80 | 20 |
| 23 | 0.4 | 0 | 100 |
| 28 | 0.4 | 0 | 100 |

Quantitation of Non-Polar Compounds: A C18 column was used to assess non-polar compounds, as they are retained in the long carbon chains under polar conditions. This method was run in both positive and negative modes, depending on each compound and whether it ionizes better with a positive or negative charge, respectively. The mobile phases used for this method were A: H2O+0.1% FA, and B: Methanol, and the temperature of the column was held at 50° C. The column used was an Agilent Poroshell 120, EC-C18 2.7 μm, 3.0×100 mm (Product #695975-302).

TABLE 6
C18 positive/negative mode gradient conditions

| Time | Flow Rate (mL/min) | % A | % B |
|---|---|---|---|
| 0 | 0.6 | 100 | 0 |
| 1.5 | 0.6 | 100 | 0 |
| 4 | 0.6 | 0 | 100 |
| 6 | 0.6 | 0 | 100 |
| 6.1 | 0.6 | 100 | 0 |
| 9 | 0.6 | 100 | 0 |

Quantitation of Organic Acids and Similarly Charged Polar Compounds: To look at organic acids, a charged C18 column was used. The gradient used for the organic method was the same as for the C18 non-polar methods, as shown in TABLE 6. There was a modification to mobile phase B for this method, in that B: ACN+0.1% FA. The column used was a Phenomenex Luna Omega, 1.6 μm, PS C18 100 Å, 100×2.1 mm (Product #00D-4752-AN).

Data analysis: Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected.

Quantitation of Organic Acids: A Synergi Hydro reversed phase column was used to assess organic acids (TABLE 7), as they are retained in charged stationary phase under polar conditions. This method was run in negative ionization mode. The mobile phases used for this method were A: H2O+0.1% FA, and B: Acetonitrile+0.1% FA, and the temperature of the column was held at 50° C. The column used was a Phenomenex Synergi 2.5 μm Hydro RP, 100 Å, 100×2 mm (Product #00D-4387-B0).

TABLE 7
Synergi Hydro negative mode gradient conditions

| Time | Flow Rate (mL/min) | % A | % B |
|---|---|---|---|
| 0 | 0.2 | 100 | 0 |
| 1.3 | 0.2 | 100 | 0 |
| 4 | 0.2 | 0 | 100 |
| 6 | 0.4 | 0 | 100 |
| 6.1 | 0.4 | 100 | 0 |
| 8.5 | 0.4 | 100 | 0 |

A list of the compounds detected in chardonnay grapeseed are shown in TABLE 8. TABLE 9 includes a list of compounds that were detected in both the grapeseed and reference chocolate.

TABLE 8
Compounds detected in grapeseed
Grapeseed (Chardonnay seed) Compounds

[Similar to: (3beta,9xi,14xi,22S,25S)-26-
Hydroxy-22,25-epoxyfurost-5-en-3-yl
6-deoxy-alpha-L-mannopyranosyl-(1-4)-[beta-
D-glucopyranosyl-(1-2)]-beta-D-glucopyranoside;
ΔMass: −720.4099 Da]
[Similar to: NP-001130; ΔMass: 22.0413 Da]
[Similar to: α,α-Trehalose; ΔMass: 35.9759 Da]
1-[(2-Methyl-2-butanyl)diazenyl]cyclohexanecarbonitrile
1_3_5-Trihydroxyxanthone
11-cyano-3,6,9-triazaundecan-1-amine
1-alpha-D-Galactosyl-myo-inositol
2,3-dihydroxypropyl 12-methyltridecanoate
2,5-Dihydroxybenzaldehyde
2_5-Diamino-6-(5′-phosphoribosylamino)-4-pyrimidineone
2-C-Methyl-D-erythritol4-phosphate
2-Dodecylbenzenesulfonic acid
3-Aminopyrrolidine
3-Carboxy-1-methylpyridinium; N-Methylnicotinicacid
3-Hydroxybenzoic acid
4-({[4-(Chlorocarbonyl)phenoxy]carbonyl}oxy)butyl acrylate
4-Aminobenzoic acid
4-Dodecylbenzenesulfonic acid
6-Methoxysalicylic acid
6-Methyl-5-(3-phenylpropyl)-2,4-pyrimidinediamine (bad)
7-Methylxanthine
Catechin
Choline
Citric acid
D-(+)-Maltose
D-(+)-Proline
DL-Carnitine
Dodecyl sulfate
Gallic acid
Gentisic acid
Glucose 1-phosphate
L-PFBS
MFCD00041919
N-Acetylneuraminicacid(NeuAc)
Ostruthin
PEG n5
Sedoheptulose
Terephthalic acid
Triethylene glycol
Trigonelline
α,α-Trehalose
α-Lactose
4-Undecylbenzenesulfonic acid
Artemotil
n-benzyloctadecylamine
Protirelin
5-Cholestene
6-C-(3-Hydroxyisopentyl) eriodictyol
5,7,3′,4′,5′-Pentahydroxy-3,6,8-trimethoxyflavone
Gericudranin E
Sphenostylin D
4_4′-Diapophytoene
Diploptene
Longicaudatin
2-(1,3-Benzodioxol-5-yl)-3,5,6,8-tetramethoxy-7-
[(3-methyl-2-butenyl)oxy]-4H-1-benzopyran-4-one
Pentabromophenyl butyrate
(5-{[(2S)-2-Acetoxypropanoyl]amino}-2,4,6-triiodo-1,3-
phenylene)bis(carbonylimino-2,1,3-propanetriyl) tetraacetate
2-Hydroxy-2_4-pentadienoate
D-Proline
1-Chloro-2,2,2-trifluoroethyl
4-Hydroxybenzaldehyde
24FC717FE5
Phentermine
ETFAA
S-Propyl phosphorodichloridothioate
ibufenac
1,3-Dicyclohexylurea
4-Propyl-4′-(trifluoromethyl)-1,1′-bi(cyclohexyl)
Eriodictyol
(+)-Catechin
3,4,2′,4′,6′-Pentahydroxydihydrochalcone
Spectinomycin
SA0425000
Procarbazine
Pongamoside A
Mirtazapine
Laxiflorin
Dodecamethylcyclohexasiloxane
6-Hydroxy-6a,12a-dehydro-alpha-toxicarol
5-Hydroxy-6-methoxy-3′,4′-methylenedioxyfurano
[2″, 3″:7, 8] flavanone
3,5-Di-O-methyl-8-prenylafzelechin-4beta-ol
NP-022231
NP-014839
NP-012551
NP-012534
methyl 3-{[2-cyano-3-(2-furyl)-3-oxoprop-1-
enyl]amino}thiophene-2-carboxylate
LSD-d3
L-Histidine
Imidazoleaceticacid
Demethylbellidifolin
D-Arginine
clean peak unknown
7_8-Dihydroxycoumarin
3-Dehydroxycarnitine
3-amino-1H-pyrazolo[4,3-c]pyridine-4,6-diol
2′-Deoxyinosine
1-Methylpyrrolinium
1′-Acetoxyeugenolacetate
[Similar to: NP-013285; ΔMass: −214.1580 Da] (really clean peak)
[Similar to: Dimethyl
(9E,18E)-1,10-bis(beta-D-glucopyranosyloxy)-6,15-dioxo-
4a,5,6,8,13a,14,15,17-octahydro-1H,10H-dipyrano[3,4-d:3′,4′-
k][1,8]dioxacyclotetradecine-4,13-dicarboxylate;
ΔMass: −714.2014 Da]
[Similar to: Dimethyl
(9E,18E)-1,10-bis(beta-D-glucopyranosyloxy)-6,15-dioxo-
4a,5,6,8,13a,14,15,17-octahydro-1H,
10H-dipyrano[3,4-d:3′,4′-
k][1,8]dioxacyclotetradecine-4,13-dicarboxylate;
ΔMass: −624.1705 Da]
[Similar to: 2-(benzyloxy)-1-methoxy-4-(2-nitrovinyl)benzene;
ΔMass: −133.0905 Da]
[Similar to: (3beta,5xi,6alpha,9xi,12beta)-20-
(beta-D-Glucopyranosyloxy)-3,12-dihydroxydammar-
24-en-6-yl beta-D-glucopyranoside; ΔMass: −620.4302 Da]
[6]-Gingerol
(S)-Carnitine
MFCD00041919
3-Carboxy-1-methylpyridinium; N-Methylnicotinicacid
PEG n5
Gentisic acid
Terephthalic acid
Glucose 1-phosphate
4-Dodecylbenzenesulfonic acid
4-Aminobenzoic acid
Choline
D-(+)-Proline
DL-Carnitine
2,5-Dihydroxybenzaldehyde
2-C-Methyl-D-erythritol4-phosphate
α-Lactose
6-Methoxysalicylic acid
1-alpha-D-Galactosyl-myo-inositol
D-(+)-Maltose
Trigonelline
Gallic acid
4-({[4-(Chlorocarbonyl)phenoxy]carbonyl}oxy)butyl acrylate
3-Aminopyrrolidine
4-Undecylbenzenesulfonic acid
11-cyano-3,6,9-triazaundecan-1-amine
1-[(2-Methyl-2-butanyl)diazenyl]cyclohexanecarbonitrile
1_3_5-Trihydroxyxanthone
[Similar to: NP-001130; ΔMass: 22.0413 Da]
Ostruthin
N-Acetylneuraminicacid(NeuAc)
α,α-Trehalose
Catechin
Citric acid
2-Dodecylbenzenesulfonic acid
Dodecyl sulfate
[Similar to: (3beta,9xi,14xi,22S,25S)-26-
Hydroxy-22,25-epoxyfurost-5-en-3-yl 6-deoxy-alpha-L-
mannopyranosyl-(1-4)-[beta-D-glucopyranosyl-
(1-2)]-beta-D-glucopyranoside;
ΔMass: −720.4099 Da]
L-PFBS
[Similar to: α,α-Trehalose; ΔMass: 35.9759 Da]
3-Hydroxybenzoic acid
2_5-Diamino-6-(5′-phosphoribosylamino)-4-pyrimidineone
2,3-dihydroxypropyl 12-methyltridecanoate
Sedoheptulose
Triethylene glycol

TABLE 9
Compounds detected in grapeseed and reference chocolate

| Compound | Category |
|---|---|
| 1-[(2-Methyl-2-butanyl)diazenyl]cyclohexanecarbonitrile | |
| 3-Carboxy-1-methylpyridinium; N-Methylnicotinicacid | |
| 7-Methylxanthine | phenol |
| Catechin | polyphenol |
| Choline | |
| D-(+)-Maltose | polyphenol |
| D-(+)-Proline | |
| DL-Carnitine | |
| N-Acetylneuraminicacid(NeuAc) | phenol |
| Sedoheptulose | |
| Trigonelline | phenol |
| α-Lactose | |
| 5,7,3′,4′,5′-Pentahydroxy-3,6,8-trimethoxyflavone | polyphenol |
| Gericudranin E | polyphenol |
| 2-Hydroxy-2_4-pentadienoate | |
| D-Proline | |
| 4-Hydroxybenzaldehyde | phenol |
| Phentermine | phenol |
| ibufenac | |
| 4-Propyl-4′-(trifluoromethyl)-1,1′-bi(cyclohexyl) | polyphenol |
| Eriodictyol | polyphenol |
| 3,4,2′,4′,6′-Pentahydroxydihydrochalcone | polyphenol |
| Spectinomycin | polyphenol |
| Pongamoside A | polyphenol |
| L-Histidine | |
| Imidazoleaceticacid | |
| D-Arginine | |
| 7_8-Dihydroxycoumarin | polyphenol |
| 3-Dehydroxycarnitine | |
| 1′-Acetoxyeugenolacetate | phenol |
| 2,5-Dihydroxybenzaldehyde | phenol |
| 2-C-Methyl-D-erythritol4-phosphate | |
| α-Lactose | polyphenol |
| 6-Methoxysalicylic acid | phenol |
| 1-alpha-D-Galactosyl-myo-inositol | polyphenol |
| D-(+)-Maltose | polyphenol |
| Trigonelline | phenol |
| Gallic acid | phenol |
| 4-({[4-(Chlorocarbonyl)phenoxy]carbonyl}oxy)butyl | polyphenol |
| acrylate | |
| 3-Aminopyrrolidine | |
| 4-Undecylbenzenesulfonic acid | phenol |
| 11-cyano-3,6,9-triazaundecan-1-amine | |
| 1-[(2-Methyl-2-butanyl)diazenyl]cyclohexanecarbonitrile | phenol |
| 1_3_5-Trihydroxyxanthone | polyphenol |
| Ostruthin | polyphenol |
| N-Acetylneuraminicacid(NeuAc) | phenol |
| α,α-Trehalose | phenol |
| Catechin | polyphenol |
| Citric acid | |
| 2-Dodecylbenzenesulfonic acid | phenol |
| Dodecyl sulfate | |
| [Similar to: (3beta,9xi,14xi,22S,25S)-26-Hydroxy-22,25- | polyphenol |
| epoxyfurost-5-en-3-yl 6-deoxy-alpha- | |
| L-mannopyranosyl-(1-4)-[beta-D-glucopyranosyl- | |
| (1-2)]-beta-D-glucopyranoside; | |
| ΔMass: −720.4099 Da] | |
| L-PFBS | |
| [Similar to: α,α-Trehalose; ΔMass: 35.9759 Da] | polyphenol |
| 3-Hydroxybenzoic acid | phenol |
| 2_5-Diamino-6-(5′-phosphoribosylamino)-4-pyrimidineone | phenol |
| 2,3-dihydroxypropyl 12-methyltridecanoate | |
| Sedoheptulose | |
| Triethylene glycol | |
| 6-Methyl-5-(3-phenylpropyl)-2,4-pyrimidinediamine | polyphenol |
| 7-Methylxanthine | phenol |

### Example 11—Comparison of Fiber and Protein Content Between Grape Seeds and Cocoa Beans

Whole grape seeds and cocoa beans were evaluated to assess their carbohydrate, fiber, protein, fat, water, and ash content, using Association of Official Agricultural Chemists (AOAC) methods. As shown in TABLE 10, These studies revealed that grape seeds and cocoa beans are similar in their contents. In addition, it was discovered that cocoa beans and grape seeds both have a very high tannin content, as well as a high flavonoid content.

TABLE 10

| | Cocoa solids | | |
|---|---|---|---|
| Nutrient (g/100 g) | (defatted) | Grape seeds | Method |
| Carbohydrate | 52 | 67-70 | Difference |
| Fiber | 30-35 | 50-55 | AOAC 2011.25 |
| Protein | 20-23 | 10-11 | AOAC 46-30, 992.15 |
| Fat | 10-12 | 8-10 | AOAC 996.06 |
| Water | 4-5 | 7-9 | AOAC 926.08, 927.05 |
| Ash | 4-6 | 2-3 | AOAC: 923.03 |

### Example 12—Fillers Generated from Non-Grape Seeds

Experimental testing was conducted for other (non-grape) fruit seeds that were processed as described in Example 7 above. In particular, informal sensory testing was then conducted using a blinded focus group (TABLE 11). These studies demonstrated that fillers derived from non-grape seeds are suitable for inclusion in chocolate products.

TABLE 11

| | | Sensory notes in filler | Suitable chocolate |
|---|---|---|---|
| Seed | Sensory notes | formula | flavor as a filler? |
| Grape | Slightly wine-y, low | Light cocoa, oreo flavor, | Yes |
| (white) | aroma, light yeast, | some dustiness | |
| | astringent | | |
| Cranberry | Low aroma, light red | Lower intensity, more | Yes |
| | fruit, slight play-doh | tart, light cocoa | |
| Raspberry | Distinct raspberry | Juicier fruit notes, more | Yes |
| | note, some dustiness, | similar to single origin | |
| | small amount of play- | cocoa, some dustiness | |
| | doh, astringent | | |
| Blackberry | Berry, play-doh, | Light cocoa, dusty, | Yes |
| | astringent | strong jammy fruit notes | |
| | | as well. | |
| Pomegranate | Jammy, some papery | Slight fruit character, | Yes |
| | notes, acidic and | light cocoa | |
| | sweet | | |
| Strawberry | Low aroma, some | Neutral flavor, slightly | Yes |
| | berry notes, light | lighter color, but not | |
| | yeast and play-doh | noticeable to consumer, | |
| | | slight cocoa | |

### Example 13—Methods of Measuring Particle Size

A micrometer screw gauge was used to measure mean particle size of wet material, including roasted and milled wet seeds, seeds to which fat or liquid has been added then wet milled into a paste, grapeseed liquor (wet milled grapeseeds), control chocolate product such as the 60.1% standard Barry Callebaut recipe chocolate of Example 7, and the chocolate with filler (chocolate made with grapeseed or other seed filler) of Example 7. To prepare the sample, an aliquot was diluted 1:1 with a neutral oil to break up any agglomerates. The micrometer screw method utilizes a measuring stage with a dial gauge. The dial of the dial gauge was turned until the measuring stage was pressed against the opposite side of the gauge. The distance between the two surfaces was measured precisely on the instrument, which indicated the size of the largest particle on the stage, reported in micrometers. Measurements were repeated and the average taken to obtain a mean particle size.

The Hegman gauge (grindometer) was used to measure mean particle size of wet material, including roasted and milled wet seeds, grapeseed liquor, seeds to which fat or liquid has been added then wet milled into a paste, seeds to which fat or liquid has been added after dry milling, grapeseed filler, berry seed filler, control chocolate product, chocolate with filler, and any other chocolate product. To prepare the sample, an aliquot was diluted 1:1 with a neutral oil to break up any agglomerates. The grindometer has a base with grooves whose heights are calibrated which can be equated to the diameter of particles. An aliquot of diluted material was poured into the grooves. Moving from the larger to the smaller end (i.e., deeper to shallower grooves), the grindometer was pressed with a steel flat edge (scraper) at a slight angle. Upon reaching the end of the gauge, a pattern in the grooves was observed. Specifically, streaking indicated that the particle size was larger than the groove depth at that point. The groove location where the streaking initially formed indicated the high end of the distribution, and where 50-75% of the surface streaking was observed, indicated the average particle size. The grindometer provided an indication of particle size distribution in addition to average particle size. Measurements were repeated to provide a mean particle size.

RoTap was used for particle size analysis of dry material or dry solid containing material, including dry milled grape seeds, cranberry seeds, raspberry seeds, blueberry seeds, blackberry seeds, pomegranate seeds, and strawberry seeds. RoTap uses a uniform rotary motion and tapping on top of a sieve stack to determine the percentage of a dry powder that falls within a specific mesh/micron size range and calculates the amount of material retained on each test sieve after running the RoTap machine. Between 300-1000 grams of the dry material was placed in the top screen and the stack was closed off. The machine was then set to rotate and the screen stack was tapped for a set period of time. At the end of the cycle, the distribution of material among each of the screens was measured. Care was taken to avoid excess oil in the material which could cause clogging of the screen at the finer mesh sizes. This process was repeated to obtain a mean particle size.

Laser diffraction and dynamic light scattering/laser diffraction were used to measure particle size in certain samples. A laser diffraction particle size analyzer is suitable for detailed analysis of a small sample (˜0.25 g). A Malvern® particle size analyzer (PSA) was used to take particle size measurements of certain samples of materials of the present invention. In PSA, a laser beam passes through a dispersed sample, and the variation in angular scattered light intensity is measured. Small particles have a small scattering angle, while large particles have a large scattering angle. The angular scattering intensity data is then analyzed to calculate the size of the particles that created the scattering pattern using the Mie theory of light scattering. The particle size is reported as a volume equivalent sphere diameter.

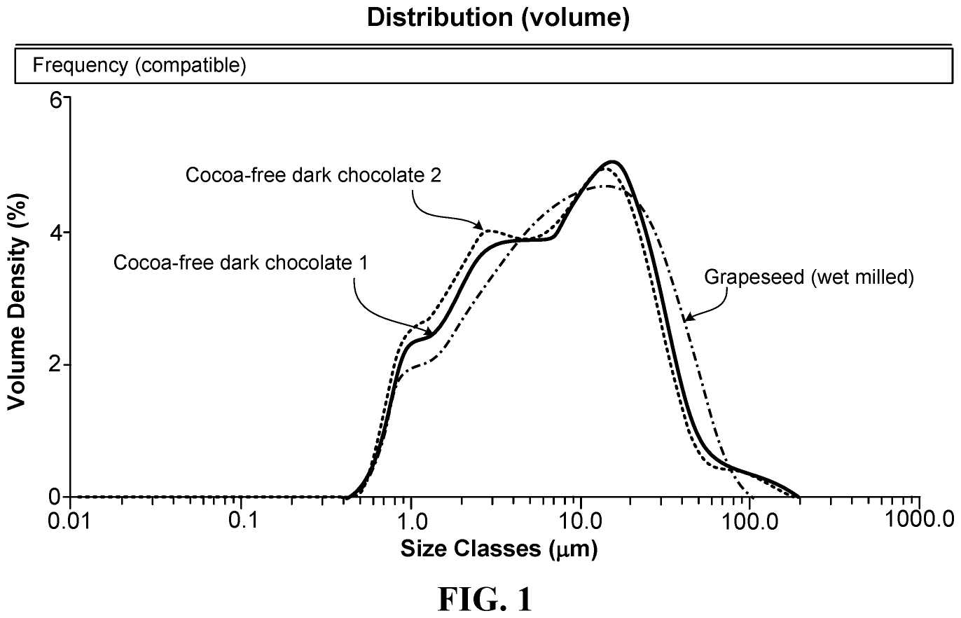

FIG. 1 shows the particle size distribution of a grapeseed liquor, i.e., wet milled grapeseed that had been ground into a paste, and cocoa-free dark chocolate products of the present invention, as measured on a Malvern® laser diffraction PSA.

TABLE 12
Particle sizes measured for wet milled
grapeseed and cocoa-free chocolates

| | Dx (10) | Dx (16) | Dx (50) | Dx (80) | Dx (84) | Dx (90) |
|---|---|---|---|---|---|---|
| Sample | (μM) | (μM) | (μM) | (μM) | (μM) | (μM) |
| Grapeseed wet | 1.47 | 2.15 | 8.51 | 23.1 | 26.7 | 34.0 |
| milling | | | | | | |
| Cocoa-free | 1.32 | 1.87 | 7.54 | 20.0 | 22.9 | 29.3 |
| dark | | | | | | |
| chocolate 1 | | | | | | |
| Cocoa-free | 1.26 | 1.73 | 6.71 | 18.2 | 20.9 | 26.7 |
| dark | | | | | | |
| chocolate 2 | | | | | | |

TABLE 12 shows particle size measurements from a Malvern® PSA. The grapeseed wet milling sample is a sample of the treated grapeseed that has been wet milled to a desired final particle size. The grapeseed wet milling sample was prepared from seed material processed according to the procedure of Example 1. The cocoa-free dark chocolate samples (cocoa-free dark chocolate 1 and cocoa-free dark chocolate 2) were fully-prepared and finished chocolates using milled grape seeds that were prepared according to the procedure of Example 1 and which also contain standard chocolate ingredients of sugar and fat. The chocolate samples were prepared with a cocoa-free formulation that did not include cacao-derived ingredients, i.e., cocoa butter and cocoa solids were entirely replaced with non-cocoa ingredients. Compositionally, the chocolate samples (based on solids information) contained 10-20 wt % grapeseed, 30-55 wt % sugar, and 25-45 wt % cocoa butter substitute, 7-20 wt % oilseed meal, 0.25-0.75 wt % lecithin, and 0 wt % cocoa solids. The formula was blended together and ground for 48 hours using a stone melanger (CocoaTown®) with the pressure set to “high.” The particle size was measured using a micrometer screw and also a Hegman gauge during the grinding process and the finished cocoa-free chocolate samples were analyzed by laser diffraction.

Referring to TABLE 12, the Dx values at the top indicate particle size measurement of the percentage of particles notated in the parentheses. For example, Dx (90) indicates the particle size of 90% of the particles such that 90% is at the notated particle size or below.

Dynamic light scattering/laser diffraction is an alternative analytical method for measuring particle size. In this method, two complementary devices (dynamic light scattering; laser diffraction) produce a highly accurate reading. The method uses a very small amount of sample diluted in an exact manner via an automated instrument. Once the dilution is complete, a laser passes through the sample. Based on the diffraction pattern from the diluted material, the machine provides an accurate measurement of the distribution of particle size. This method can be used on a chocolate mass as well as a dry material because of the flexibility of the instrument.

A dynamic light scattering/laser diffraction analysis (DLS/LD) was obtained for detailed analysis of three finished chocolates where no cocoa solids were used, i.e., a cocoa-free chocolate in which cocoa solids and cocoa butter have been wholly replaced by non-cocoa ingredients. The cocoa-free dark chocolate samples were fully-prepared and finished chocolates using milled grape seeds that were prepared according to the procedure of Example 1 and which also contain standard chocolate ingredients of sugar and fat. The chocolate samples were prepared with a cocoa-free formulation that did not include cacao-derived ingredients, i.e., cocoa butter and cocoa solids were entirely replaced with non-cocoa ingredients. Compositionally, the chocolate samples (based on solids information) contained 10-20 wt % grapeseed, 30-55 wt % sugar, 25-45 wt % cocoa butter substitute, 7-20 wt % oilseed meal, 0.25-0.75 wt % lecithin, and 0 wt % cocoa solids. The formula was blended together, mixed at 35° C. for 30 minutes, and ground for 48 hours using a stone melanger (CocoaTown®) with the pressure set to “high.”

TABLE 13
Particle sizes for cocoa-free dark chocolates using DLS/LD

| | Dx (10) | Dx (50) | Dx (90) | Mean size |
|---|---|---|---|---|
| Sample | (um) | (um) | (um) | (um) |
| Cocoa-free dark | 2.222 | 13.774 | 46.427 | 20.399 |
| chocolate 1 | | | | |
| Cocoa-free dark | 2.143 | 12.802 | 43.610 | 19.155 |
| chocolate 2 | | | | |
| Cocoa-free dark | 2.095 | 12.368 | 42.787 | 18.696 |
| chocolate 3 | | | | |

TABLE 13 shows measured particle sizes for three finished dark chocolate samples made from milled grapeseed, sugar, and fat ingredients. As in the previous table showing laser diffraction data obtained using the Malvern® technique, the Dx values at the top indicate particle size measurement of the percentage of particles notated in the parentheses. The mean particle size to the right in the table is the average of the distribution and is very similar to a micrometer reading on a sample.

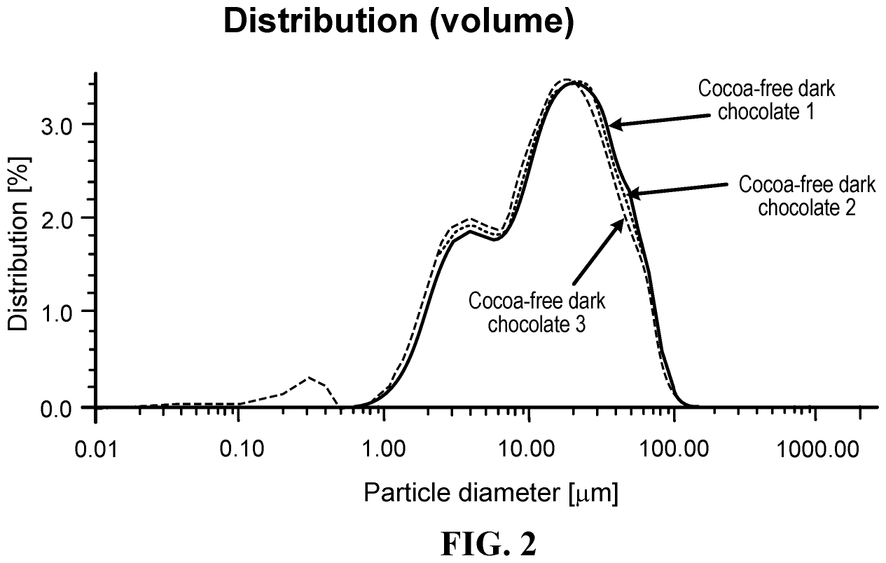

FIG. 2 also shows more statistical analysis on the sample including standard deviation and total span which indicates how wide the distribution is on the sample. Specifically, the samples were dispersed in water and vortexed for 30 seconds before measurement to obtain 12-13% obscuration. The samples were then sonicated for 30 minutes (at 50 w) before measurement and during measurement. A tight particle size is preferred for chocolate and will have a smoother mouthfeel. This particular sample preparation utilizes sonication which prevents sample agglomerates from forming during the measurement. Such agglomerates can create a false indication of larger particle size.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A composition consisting essentially of roasted and ground fruit seeds.

2. The composition of claim 1, wherein the ground fruit seeds have a particle size less than 350 microns.

3. The composition of claim 1, wherein the fruit seeds are grape seeds.

4. The composition of claim 3, wherein the grape seeds are selected from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, grenache blanc grapes, and any combination thereof.

5. The composition of claim 1, wherein the fruit seeds are selected from cranberry, raspberry, blueberry, strawberry, blackberry, pomegranate, kiwi, watermelon, muskmelon, cantaloupe, honeydew, papaya, passionfruit, starfruit, tomato, tomatillo, dragon fruit, guava, soursop, calamansi, pumpkin, squash, okra, cucumber, bell pepper, eggplant, pears, apples, cherimoya, pineapple, quince, lingonberries, date, fenugreek, and any combination thereof.

6. The composition of claim 1, wherein the ground fruit seeds have a particle size less than 250 microns.

7. The composition of claim 1, wherein the ground fruit seeds have a particle size less than 150 microns.

8. A consumable product comprising a filler consisting essentially of roasted and ground fruit seeds.

9. The consumable product of claim 8, wherein the ground fruit seeds have a particle size less than 350 microns.

10. The consumable product of claim 8, wherein the consumable product is a chocolate.

11. The consumable product of claim 10, wherein the chocolate comprises:
about 0.01% to about 35% by weight of the filler;
about 20% to about 55% by weight cocoa butter;
about 20% to about 60% by weight sugar; and optionally
about 0.5% to about 25% by weight cocoa solids.

12. The consumable product of claim 10, wherein the chocolate comprises:
about 17.5% by weight of the filler;
about 37.5% by weight cocoa butter;
about 40% by weight sugar; and optionally
about 5% by weight cocoa solids.

13. The consumable product of claim 8, wherein the fruit seeds are grape seeds.

14. The consumable product of claim 13, wherein the grape seeds are selected from table grapes, concord, niagra, chardonnay, sauvignon blanc, muscat, sultana, riesling, pinot gris, pinot grigio, cabernet sauvignon, merlot, pinot noir, shiraz, albarino, malbec, grenache, solaris, zinfandel, cabernet franc, tempranillo, carmenere, mataro, sangiovese, regent, black muscat, chasselas, wild grape, nebbiolo, montepulcian, gewurztraminer, barbera, chenin blanc, carignan, semillon, gamay, petit verdot, trebbiano, cinsault, gruner veltliner, silvaner, petit sirah, grenache blanc grapes, and any combination thereof.

15. The consumable product of claim 8, wherein the fruit seeds are selected from cranberry, raspberry, blueberry, strawberry, blackberry, pomegranate, kiwi, watermelon, muskmelon, cantaloupe, honeydew, papaya, passionfruit, starfruit, tomato, tomatillo, dragon fruit, guava, soursop, calamansi, pumpkin, squash, okra, cucumber, bell pepper, eggplant, pears, apples, cherimoya, pineapple, quince, lingonberries, date, or fenugreek, and any combination thereof.

16. The consumable product of claim 8, wherein the ground fruit seeds have a particle size less than 250 microns.

17. The consumable product of claim 8, wherein the ground fruit seeds have a particle size less than 150 microns.

18. A method for making a substitute for dry cocoa solids from non-cocoa seeds, wherein the method comprises:
(a) treating a plurality of non-cocoa fruit seeds with a chemical solution and/or an enzymatic solution, thereby producing treated seeds;
(b) reducing the moisture content of the treated seeds to 25% w/w or less of the treated seeds, thereby producing dried seeds;
(c) roasting the dried seeds, thereby producing roasted seeds; and
(d) grinding the roasted seeds, thereby producing a ground seed composition, wherein the composition is effective as a substitute for dry cocoa solids.

19. A method for making a chocolate product containing a filler prepared from non-cocoa seeds, wherein said method comprises:
(a) treating a plurality of non-cocoa fruit seeds with a chemical solution and/or an enzymatic solution, thereby producing treated seeds;
(b) reducing the moisture content of the treated seeds to 25% w/w or less of the treated seeds, thereby producing dried seeds;
(c) roasting the dried seeds, thereby producing roasted seeds; and
(d) grinding the roasted seeds, thereby producing a ground seed composition, wherein the composition is used as all or a portion of the filler.

20. The method of claim 18, wherein the plurality of non-cocoa fruit seeds are cleaned prior to step (a) to remove impurities, e.g., chaff, broken material, stones, skins, stems, and/or sticks.

21. The method of claim 20, wherein the plurality of non-cocoa fruit seeds are cleaned using a destoner, a scalping deck, an aspiration channel, a sizing deck, an optical sorter, a sieve, or a combination thereof, such that the impurities are less than 0.5% w/w of the seeds.

22. The method of claim 18, wherein step (a) comprises using a chemical solution comprising a caustic agent (e.g., sodium hydroxide, potassium hydroxide, sodium carbonate, calcium carbonate, calcium hydroxide, potassium bicarbonate, iodine, or a combination thereof), an acidulant (e.g., acetic, adipic, citric, fumaric, lactic, malic, phosphoric and tartaric acids, glucono-delta-lactone, or a combination thereof), and/or an oxidizing agent (e.g., hydrogen peroxide).

23. The method of claim 22, wherein the seeds are treated with the chemical solution with agitation at 60° C. to 150° C. (e.g., 75° C. to 100° C.) for 30 minutes to 2 hours, such that the treated seeds have a pH of 5.5-10.5 (e.g., 8-10).

24. The method of claim 18, wherein step (a) comprises using an enzymatic solution comprising one or more enzymes comprising cellulase, tannase, pectinase, xylase, and/or hemicellulase, preferably cellulase and/or hemicellulose, in an aqueous solution.

25. The method of claim 24, wherein the seeds are treated with the enzymatic solution with agitation for 30 minutes to 2 hours.

26. The method of claim 18, wherein step (a) comprises treating the seeds with the chemical solution and/or the enzymatic solution by soaking, spraying, boiling, agitating, coating, or a combination thereof.

27. The method of claim 18, wherein step (a) comprises treating the seeds with both the chemical solution and the enzymatic solution, either simultaneously or sequentially.

28. The method of claim 18, wherein step (b) comprises reducing the moisture content of the treated seeds to 20% w/w, 15% w/w, 10% w/w, 6% w/w, or less of the treated seeds.

29. The method of claim 18, wherein step (c) comprises roasting the dried seeds at 125° C. to 200° C., preferably 140° C. to 200° C. or 150° C. to 175° C., for 20 minutes to 2 hours.

30. The method of claim 18, wherein the moisture content of the roasted seeds is less than 2% w/w of the roasted seeds.

31. The method of claim 18, wherein step (d) comprises using one or more dry milling techniques and/or one or more wet milling techniques, to produce the ground seed composition.

32. The method of claim 18, wherein step (d) comprises using a wet mill (e.g., a stone mill, a colloid mill, a blade mill, or a corundum mill) to grind the roasted seeds together with a fat or liquid oil.

33. The method of claim 32, wherein the fat or liquid oil is in the amount of 30-60% by weight of the roasted seeds.

34. The method of claim 18, wherein step (d) comprises grinding the roasted seeds to a particle size less than about 350 μm.

35. The method of claim 18, wherein step (d) comprises grinding the roasted seeds to a particle size less than about 250 μm or less than about 150 μm.

36. A method for making a substitute for dry cocoa solids from non-cocoa seeds, wherein the method comprises:
(a) cleaning a plurality of non-cocoa fruit seeds to remove impurities, thereby producing cleaned seeds;
(b) roasting the cleaned seeds at 125° C. to 200° C., preferably 140° C. to 200° C., for 20 minutes to 2 hours, thereby producing roasted seeds; and
(c) grinding the roasted seeds, thereby producing a ground seed composition, wherein the composition is effective as a substitute for dry cocoa solids.

37. A method for making a chocolate product containing a filler prepared from non-cocoa seeds, wherein said method comprising:
(a) cleaning a plurality of non-cocoa fruit seeds to remove impurities, thereby producing cleaned seeds;
(b) roasting the cleaned seeds at 125° C. to 200° C., preferably 140° C. to 200° C., for 20 minutes to 2 hours, thereby producing roasted seeds; and
(c) grinding the roasted seeds, thereby producing a ground seed composition, wherein the composition is used as all or a portion of the filler.

38. The method of claim 36, further comprising reducing the moisture content of the cleaned seeds prior to step (b).

39. The method of claim 18, wherein step (c) comprises using a wet mill (e.g., a stone mill, a colloid mill, a blade mill, or a corundum mill) to grind the roasted seeds together with a fat or liquid oil, wherein the fat or liquid oil is in the amount of 30-60% by weight of the roasted seeds.

40. The method of claim 36, wherein step (d) comprises grinding the roasted seeds to a particle size less than about 350 μm, less than about 250 μm, or less than about 150 μm.

41. The method of claim 19, wherein the chocolate product further comprises cocoa butter, sugar, and optionally cocoa solids.

42. The method of claim 19, wherein the chocolate product further comprises a cocoa butter replacement, substitute, or equivalent (CBE), sugar, and optionally cocoa solids, seed meal, and/or lecithin.
